(19) United States
(12) Patent Application Publication
(10) Pub. No.: US 2009/0084658 A1
(43) Pub. Date: Apr. 2, 2009

(54) Sliding loader with improved air bearing

(76) Inventor: Clemente Edgardo Quintana, Houston, TX (US)

Correspondence Address: John William Sparks, Suite 116, 1350 Nasa Parkway, Houston, TX, 77058, US

(21) Appl. No.: 11/906,038

(22) Filed: Sep. 29, 2007

(51) Int. Cl. B65G 37/00

(52) U.S. Cl. 198/602; 198/721

(57) ABSTRACT

A sliding loader is disclosed comprising an undercarriage, one or more air bearings attached to the undercarriage, one or more forced air means provide pressurized air to the air bearings, and one or more lifting means for moving payloads, wherein the lifting means are attached to the undercarriage. An improved air bearing is disclosed comprising an optional top surface, wherein the top surface has an orifice; a bottom surface, wherein the bottom surface is porous; an inflatable chamber, wherein the inflatable chamber is positioned between the top surface and the bottom surface; an optional bottom framework, wherein the bottom framework is attached to the bottom surface; and one or more optional elastic members, wherein the top ends of the elastic members are attached near the top end of the inflatable chamber and the bottom ends of the elastic members are attached near the bottom end of the inflatable chamber.

### FIELD OF INVENTION

The embodiments of this invention relate to moving payloads on nearly smooth surfaces or in inhospitable environments on nearly smooth surfaces, particularly the cramped baggage compartments of commercial airliners, flammable environments, or explosive environments.

### BACKGROUND OF THE INVENTION

The Applicant became aware of the injurious working conditions of baggage handlers for the airline industry and realized the need for a better way of loading baggage that would significantly decrease the likelihood and severity of on-the-job injuries for baggage handlers. The Applicant's sliding loader decreases the physical stress incurred while handling baggage.

The baggage compartment of a commercial passenger airplane has less than five feet of vertical height. The baggage handlers must load the baggage in this cramped space by working on their knees for long periods of time. Baggage handling is stressful on muscles, ligaments, and joints. Baggage handlers suffer from many different injuries, but most of the injuries occur to the spine, shoulders, and arms.

Baggage handling takes young, able-bodied people and, over time, reduces them to disabled or partially disabled workers, who are still young. The injured baggage handlers are given treatments, time off to heal, and, eventually, less physically stressful jobs with the airlines. After being seriously injured on the job, baggage handlers are unlikely to return to their jobs as baggage handlers.

If the baggage handlers are able to return to their jobs, it is only a matter of time until the next serious injury occurs. The injured baggage handlers do not have the choice to remain working as baggage handlers, even if they like their jobs. Many former baggage handlers still suffer from their injuries even when performing less stressful jobs for the airlines.

The injuries suffered by baggage handlers cost the airline industry several millions of dollars each year. The airline industry pays for the medical treatments, time off from work, and then, eventually, has to find the baggage handlers a less stressful job or pay disability claims on their injured baggage handlers. Baggage handlers and the airline companies would welcome a better way to load baggage that would lessen the frequency and severity of injuries.

The commercial airlines, in their efforts to cut costs and become more competitive, would like to lower the on-the-job injury rate for baggage handlers. The problem was that there were no acceptable alternatives to the current way of handling baggage. The physical work of baggage handling has not changed in several decades.

The injuries and disabilities due to baggage handling keep occurring. The injuries to baggage handlers will continue to occur because the work remains the same. Applicant's sliding loader was created specifically to lessen the physical stress of baggage handling. It is expected that the severity of injuries to baggage handlers will decrease by using Applicant's sliding loader.

The Applicant's sliding loader uses air bearings to support the mass of the sliding loader. There are many different types of air bearings. The patents on many air bearings have expired. The sliding loader can use many different kinds of air bearings.

Most air bearings are similar in that they have top air inlet area and a bottom air emission area. The components of most air bearings are stationary relative to the other components of the air bearing. The improved air bearing, disclosed herein, has a bottom surface, wherein the entire bottom surface displaces vertically in relation to some other components of the air bearing when the air bearing is emitting air. The improved air bearing is functionally different from other air bearings that have a vertical displacement of the bottom surface.

The Applicant made a prototype of his sliding loader and tested it to demonstrate that it works. The Applicant's prototype lacks wheels and allows the operator to move heavy payloads by applying very little horizontal force from the operator's legs. Applicant is confident that his sliding loader will lower the frequency and severity of the on-the-job injuries for baggage handlers and will increase the productivity of baggage handlers by enabling the baggage handlers to move multiple bags at the same time.

### SUMMARY

The present invention is directed to a sliding loader that allows people to move heavy payloads while incurring less physical stress and exerting less physical effort. The sliding loader has an undercarriage having a top side and a bottom side; one or more forced air means; one or more air bearings attached to the bottom side of the undercarriage; and one or more lifting means attached to the undercarriage for moving payloads, wherein the forced air means supply pressurized air to the air bearings and the air bearings forcefully emit air towards an underlying surface, when desired, whereby friction between the air bearings and the underlying surface is reduced by the emitted air.

When friction is decreased, a small applied horizontal force can move very heavy payloads horizontally. This allows people to move heavy payloads by applying very little physical force. With less force being exerted by people, less stress is incurred by the person's body.

The undercarriage is a framework disposed horizontally. The undercarriage can have many different configurations. The undercarriage can be a planar piece of metal, a flat metal framework, a lattice framework, or a molded framework. The undercarriage can be very small or extensive, depending upon the desired size.

The term “air” means any air, gas, or fluid of any kind or any mixture of air, gas, or fluid. A forced air means is any means of delivering pressurized air or any source of pressurized air. The forced air means provides pressurized air to the air bearings or any other device needing pressurized air.

There are many different types of forced air means. The forced air means can be a compressed gas vessel; a blower; an air pump connected to a compressed gas vessel; a fan; a fluid pump; a combustion chamber; a dewar; a compressed gas cylinder; an explosive chamber; a liquefied gas and vaporizer, wherein the liquefied gas is vaporized to a gaseous form; or a duct supplying pressurized air from a separate source that is not a component of the sliding loader.

Air bearings are devices that receive pressurized air and emit that air forcefully toward an underlying surface, usually through a perforated, porous, or open bottom surface. The air bearings receive pressurized air from the forced air means and emit that pressurized air from the bottom surface of the air bearings to decrease friction. There are many different kinds of air bearings. The patents on several different kinds of air bearings have expired.

The improved air bearing is a preferred component on the sliding loader. The improved air bearing has an optional top surface, an inflatable chamber, a bottom surface, one or more optional elastic members, and an optional bottom framework. The top surface of the improved air bearing has a planar horizontal surface and one or more orifices for receiving pressurized air. The top surface of the improved air bearing may be a partial enclosure. The top surface of the improved air bearing may have one or more attachment sites.

The inflatable chamber is a partial or full enclosure, wherein that enclosure is expandable, elastic, or inflatable. The inflatable chamber is capable of having a vacuous space within the enclosure of the inflatable chamber.

The inflatable chamber has a perimeter material usually enclosing a vacuous space within the inflatable chamber. The perimeter material of the inflatable chamber of the improved air bearing has a top end and a bottom end. The top end of the perimeter material of the inflatable chamber is attached to the top surface of the improved air bearing. The perimeter material of the inflatable chamber of the improved air bearing is preferably non-porous and may be an elastic material.

The bottom surface of the improved air bearing is a planar horizontal surface having one or more orifices. The bottom surface of the improved air bearing may have one or more attachment sites. The bottom end of the perimeter material of the inflatable chamber is attached to the bottom surface of the improved air bearing. The elastic members of the improved air bearing are elastic strings, fibers, ropes, material, lanyards, or straps.

The elastic members of the improved air bearing have a top end and a bottom end. The top ends of the elastic members are attached to or near the top surface of the improved air bearing. The bottom ends of the elastic members are attached to or near the bottom surface of the improved air bearing.

The vacuous space of the inflatable chamber is continuous with the orifices of the top surface of the improved air bearing. When pressurized air enters the orifices of the top surface of the improved air bearing, the pressurized air fills the vacuous space within the inflatable chamber.

The bottom framework of the improved air bearing is a horizontally disposed frame. The bottom framework is attached to the bottom surface of the improved air bearing. The bottom framework of the improved air bearing provides structural support for the bottom surface of the improved air bearing and can serve as an attachment site for the elastic members of the improved air bearing.

When pressurized air enters the inflatable chamber of the improved air bearing, the inflatable chamber lengthens vertically, lowers the bottom surface of the improved air bearing, and stretches the elastic members of the improved air bearing. When the air pressure inside the inflatable chamber decreases below a certain pressure, the elastic members pull upward on the bottom surface of the improved air bearing to raise the bottom surface of the improved air bearing.

A lifting means is any means for moving payloads in any direction relative to the position of the undercarriage. The lifting means comprises a powering means, a positional apparatus, and a payload carrier. The lifting means are usually attached to the undercarriage. Actuators are devices for moving or controlling something.

The powering means is any means of powering the lifting means. One or more actuators can be the powering means for the lifting means. There are many kinds of actuators, including hydraulic actuators, solenoid actuators, pneumatic actuators, electromechanical actuators, electromagnetic actuators, and mechanical actuators. The forced air means may provide power to actuate the actuators on a lifting means.

A powering means for the lifting means can be a winch pulling on cables, ropes, or belts; a hydraulic actuator with piston; a pneumatic actuator with piston; a mechanical jack powered by electric motors; a solenoid actuator; and a mechanical jack powered manually.

The positional apparatus is any changeable apparatus capable of changing the position of the payload carrier. The positional apparatus of the lifting means can have many different configurations for moving payloads. The positional apparatus can have a front end loader configuration, a forklift configuration, a hoist configuration, a three point hitch configuration, an elevator configuration, or any extendable, either vertically or horizontally, version of these configurations, such as a horizontally extendable forklift configuration, an extendable hoist configuration, or an extendable front end loader configuration.

The payload carrier is any means of holding, engaging, or controlling a payload. The lifting means can have different types of payload carriers, such as a fork, a scoop, a prong, a hoist, a hook, an enclosure, a point, or a platform. The powering means of the lifting means provides power to the positional apparatus to change the configuration of the positional apparatus and the payload carrier relative to the position of the undercarriage.

The sliding loader may have optional features, such as: one or more power supply means, a seat for the operator of the sliding loader, motors, engines, electrical components, wheels, braking systems, one or more powering means not associated with the lifting means, vertically displaceable wheels, actuated wheels, pressure release valves, air flow regulators, castered wheels, actuators not associated with the lifting means, braking systems associated with the wheels, and motorized wheels.

A power supply means is any means of supplying power to a power consuming device. The “power supply means” expressly includes batteries, AC/DC generators, internal combustion engines, AC/DC power cords, fuel cells, pressurized air ducts, and electric power sources of any kind.

These and other features, aspects, and advantages of the present invention will become better understood with regard to the following description, appended claims, and accompanying drawings where:

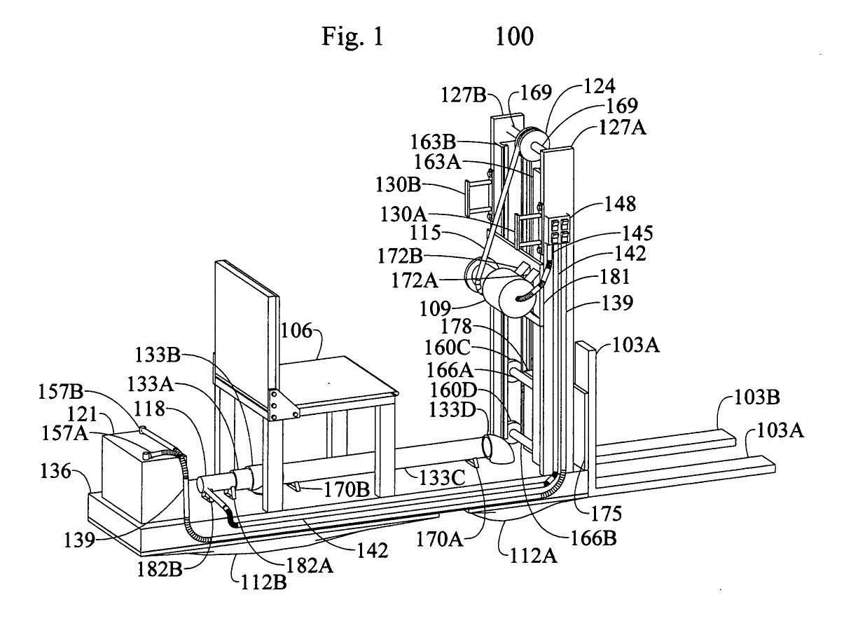

FIG. 1 depicts a downward left perspective view of embodiment 100 of the sliding loader,

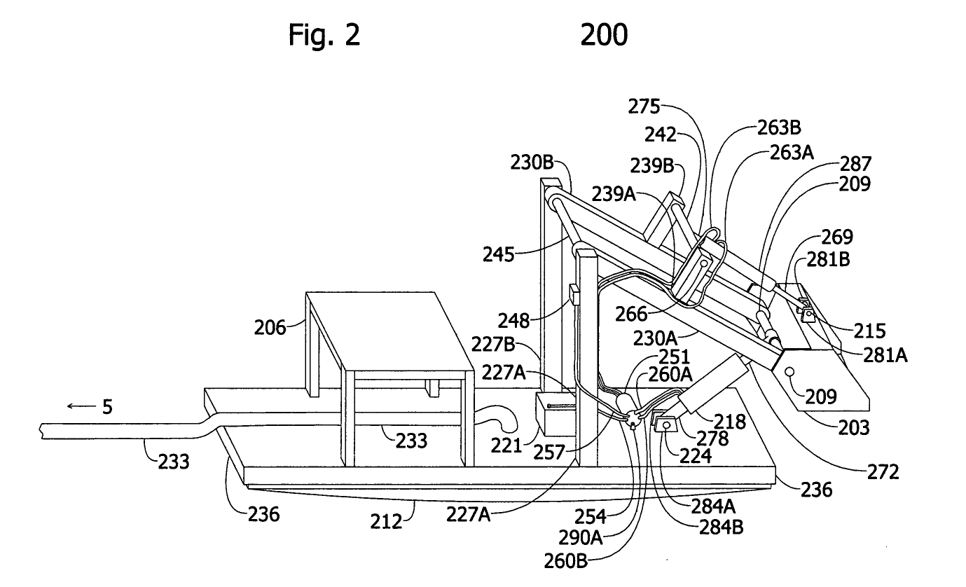

FIG. 2 depicts a downward left perspective view of embodiment 200 of the sliding loader,

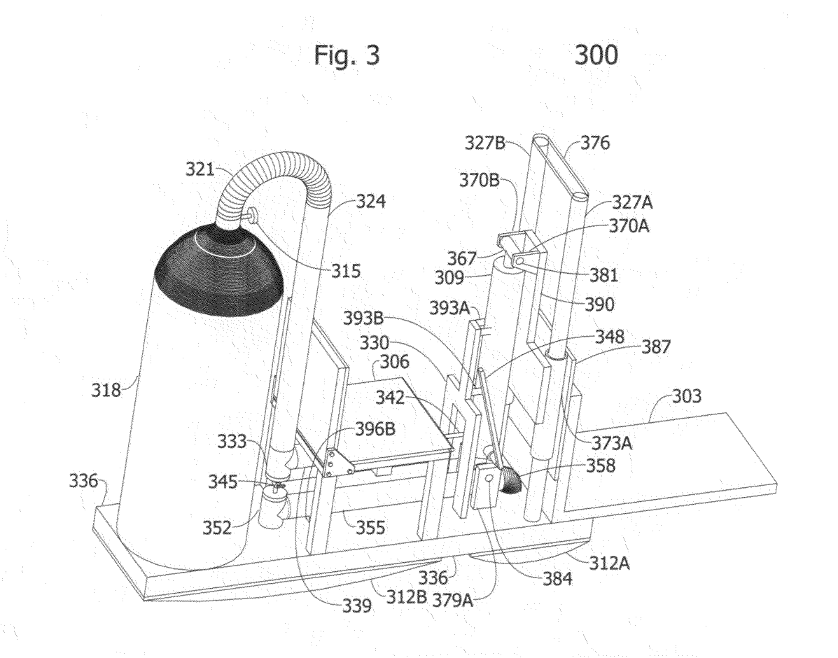

FIG. 3 depicts a downward left perspective view of embodiment 300 of the sliding loader,

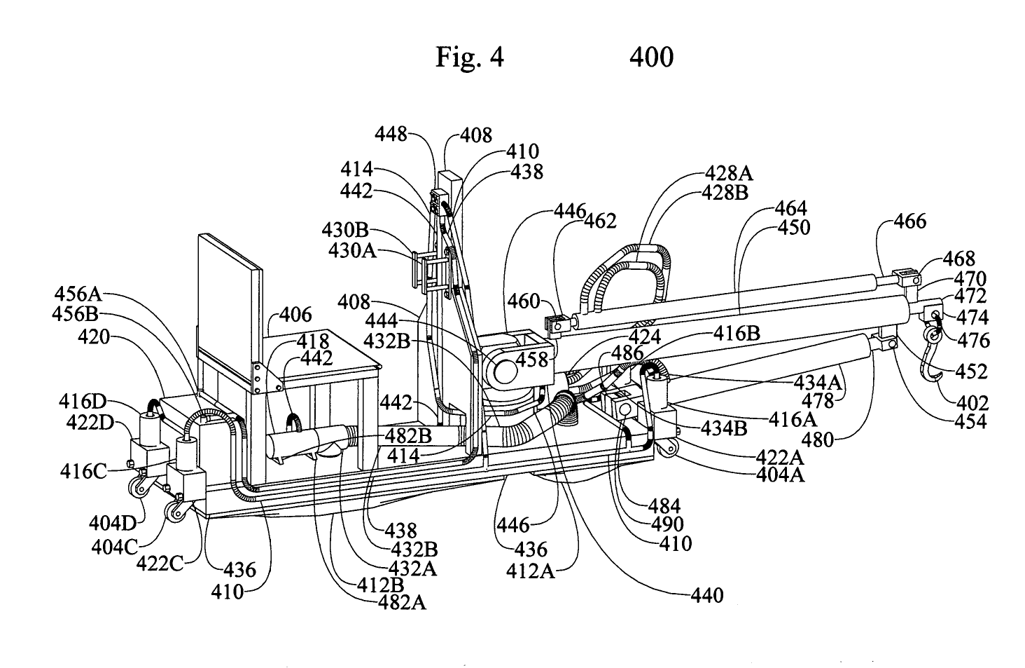

FIG. 4 depicts a downward left perspective view of embodiment 400 of the sliding loader, and

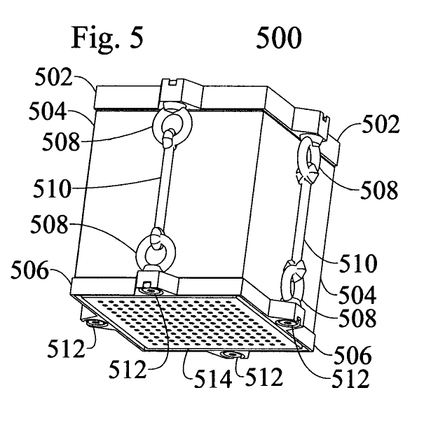

FIG. 5 depicts an upward perspective view of a version of an improved air bearing that is labeled 500.

### DETAILED DESCRIPTION

In accordance with some embodiments described herein, a sliding loader is disclosed. The sliding loader comprising an undercarriage having a top side and a bottom side; one or more optional forced air means to provide pressurized air to any air using devices; one or more air bearings having a top side and a bottom side, wherein the bottom side has a bottom surface, wherein the bottom surface of the air bearing is perforated, porous, or open, wherein the top sides of the air bearings are attached to the bottom side of the undercarriage, wherein the air bearings are capable of emitting air from the bottom surface of the air bearings, the air bearings receive pressurized air from the forced air means, and the air bearings emit pressurized air from the bottom surface of the air bearings, when desired; one or more lifting means attached to the undercarriage for moving payloads relative to the position of the undercarriage; an optional seat for the operator; one or more optional power cables for conducting electrical power to power consuming devices; an optional control box; optional handles for the operator to control the sliding loader; one or more optional duct systems, whether branched or linear, to convey pressurized air to any device needing pressurized air; one or more optional undercarriage wheels, whether displaceable or not, that are attached to the undercarriage; one or more optional motors for powering devices on the sliding loader; one or more optional power supply means to provide power to any power consuming devices on the sliding loader, including the lifting means, if desired; optional pressure release valves; and optional air flow regulators.

The forced air means may be a power supply means for the lifting means, if desired. The invention does not require all the advantageous features and all of the advantages to be incorporated into every embodiment of the invention.

When the air bearings are functioning, the sliding loader can be horizontally moved along the underlying surface with very little force, even when the sliding loader is carrying a heavy payload in the lifting means. The operator of the sliding loader can generally supply the force needed to overcome the friction with his or her legs and cause horizontal movement of the sliding loader even when the sliding loader is carrying a payload of several hundred pounds. Some embodiments have motorized undercarriage wheels for effectuating horizontal movement of the sliding loader.

For purposes of description, the “front” refers to the end of the embodiment that has a lifting means or, if multiple lifting means, the direction in which the operator faces when sitting in the operator's seat. The “back” or “rear” refers to the end or side of the embodiment that opposes the front of the embodiment. “Forward” or “frontward” refers to a position toward the front of the embodiment. “Backwards” or “rearward” refers to a position toward the back of the embodiment. “Right” refers to the right side of the embodiment when the observer is facing the front of the embodiment. “Left” refers to the left side of the embodiment when the observer is facing the front of the embodiment.

A “shackle end” is a shackle attached to the end of a member, wherein the attachment site of the shackle end to the end of the member does not pivot and the orifices of the shackle are positioned away from the end of the member. A shackle end can be attached to another member, wherein the other member has an orifice and the other member can fit within the space between the orifices of the shackle, by positioning a pin, bolt, shackle bolt, or clevis pin within the orifices of the shackle and the orifice of the other member. This attachment of a shackle end to another member creates a pivoting joint or a joint capable of pivoting if the other member is capable of pivoting.

The particular shackle end used in one embodiment has two parallel planar structures, and a crosspiece. The two parallel planar structures of the shackle end comprise a first planar structure and a second planar structure, wherein the two planar structures are parallel to each other and usually aligned as mirror images of each other. A crosspiece is a member that is disposed transversely relative to the longitude of one or more members.

The parallel planar structures of the shackle end have a first end and a second end. The crosspiece has a front side, a back side, a first end, a middle region, and a second end. The first end of the front side of the crosspiece of the shackle end is attached to the second end of the first parallel planar structure of the shackle end. The second end of the front side of the crosspiece of the shackle end is attached to the second end of the second parallel planar structure of the shackle end. The middle region of the back side of the crosspiece is attached to the end of a member.

The first parallel planar structure has a transverse orifice extending completely through the planar structure near the first end of the first parallel planar structure. The second parallel planar structure has a transverse orifice extending completely through the planar structure near the first end of the second parallel planar structure. The transverse orifices of the parallel planar structures of the shackle end are aligned on the same axis.

A clevis pin is a pin designed to occupy the orifices of a shackle or shackle end. The removable clevis pin of the shackle end is capable of occupying the orifice of a non-associated member. When the removable clevis pin is in place within the orifices of the shackle end and the orifice of a non-associated member, the clevis pin pivotably attaches the shackle end to a non-associated member. This shackle end and pin arrangement form a pivoting joint that is used on one embodiment of the sliding loader.

The undercarriage is a planar member, framework or frame, usually a planar frame. The undercarriage may be composed of metal, alloys, fiberglass, wood, or composites. It is preferable for the undercarriage to be made of lightweight, durable, and strong materials. The undercarriage is disposed horizontally. The other components of the sliding loader are generally attached to the undercarriage.

The term “air” means any air, gas, or fluid of any kind or any mixture of air, gas, or fluid. A forced air means is any means of delivering pressurized air or any source of pressurized air. The term “duct” or “ducts” expressly includes any duct, hose, conduit, or pipe for conveying air, liquid, gas, fluid, or any mixture of air, liquid, gas, or fluid. The term “duct” or “ducts” expressly includes hydraulic hoses, gas lines, air ducts, water hoses, and oil lines. A “duct system” is a duct or series of ducts, whether branched, linear, or both branched and linear.

A “forced air means” expressly includes a duct supplying pressurized air, even when the pressurized air is supplied by a unit away from or not present on the sliding loader. A forced air means can be a compressed gas vessel; a blower; an air pump connected to a compressed gas vessel; a liquefied gas and vaporizer, wherein the liquefied gas is vaporized to a gaseous form; a gas pump; a dewar; a duct supplying pressurized air from a forced air means on the sliding loader or a separate source; an air pump; a combustion chamber; a compressed gas cylinder; an explosive chamber, a fan; a fluid pump; or any other gas or fluid pressurizing device. There are many different forced air means. A forced air means can serve as a power supply means on some embodiments of the invention.

An air bearing is any device that creates a thin film of pressurized air between that device and a surface. The term “air bearing” expressly includes an air bearing, an air bearing within a load module having a flow control valve, a fluid bearing, a fluid dynamic bearing, a hydrostatic bearing, a gas bearing, a foil bearing, a journal bearing, an orifice fed air bearing, an aerostatic bearing, a porous media fed air bearing, a dynamic tilting pad fluid bearing, a flat pad air bearing, a dovetail style air bearing, a rectangular air bearing, an air bushing style air bearing, or any device that creates a thin film of pressurized air, gas, or fluid between that device and a surface.

There are many different kinds of air bearings. Several patents concerning air bearings are expired. The air bearings have a top side usually having one or more intake orifices for receiving pressurized air from one or more forced air means; a bottom side having a porous, perforated, or open bottom surface for forcefully emitting air; and an orifice between the top side and the bottom side for conducting air from the top side to the bottom side of the air bearing.

An air emission surface is any surface, side, or opening that emits air. An “air emission surface” expressly includes a fluid emission surface. The top side of the air bearing can be made of aluminum, plywood, fiberglass, composite, or polymer and is generally constructed as a partial enclosure.

The bottom surface of the air bearing can be made of perforated leather, perforated or porous fabric, perforated or porous polymer, or have a shroud around the exterior perimeter of an opening in the bottom surface of the air bearing, wherein the shroud is made of metal, fiberglass, composite, or polymer. The bottom surface of the air bearing is the air emission surface. In the shroud configuration of an air bearing, the bottom surface of the air bearing has an orifice of large size and the shroud usually has a downward projecting rubber, silicone, tetrafluoroethane, or polymer edge that surrounds the opening on the bottom side of the air bearing. The descriptions of certain types of air bearings in this written description are not to be construed to limit the previously defined broad definition of “air bearing.”

The top sides of the air bearings are usually attached to the bottom side of the undercarriage. The air emission surface of the air bearings is directed away from the bottom side of the undercarriage. When the sliding loader is operating on an underlying surface, the air emission surfaces of the air bearings are adjacent to the underlying surface. The air being emitted from the air bearings during operation of the sliding loader allows the sliding loader to slide horizontally on flat or smooth surfaces with little horizontal force or physical effort.

The improved air bearing is a preferred component on the sliding loader. The improved air bearing has an optional top surface, an inflatable chamber, a bottom surface, one or more optional elastic members, and an optional bottom framework. The top surface of the improved air bearing is a planar horizontal surface having one or more orifices for receiving pressurized air. The top surface of the improved air bearing may be a partial enclosure.

The top surface of the improved air bearing may have one or more attachment sites. The top surface of the improved air bearing is generally made of polymer, metal, composite, or wood. The orifices in the top surface of the improved air bearing are usually vertical orifices extending completely through the top surface of the improved air bearing. The orifices are usually centrally located in the top surface of the improved air bearing.

The inflatable chamber has a perimeter material enclosing a vacuous space within the inflatable chamber. The perimeter material of the inflatable chamber of the improved air bearing has a top end and a bottom end. The perimeter material of the inflatable chamber is a flexible material that can be semiporous or nonporous. The preferable material for the perimeter material is non-porous. The perimeter material of the inflatable chamber may be an elastic material.

The top end of the perimeter material of the inflatable chamber is attached to the top surface of the improved air bearing. The perimeter material of the inflatable chamber may be attached to the top surface, bottom surface, or bottom framework of the improved air bearing by using glue, stitching, rivets, clamps, or any combination of these attachment means.

A preferred method of attaching the perimeter material to the bottom surface of the improved air bearing is to cut a groove or trench in the downward surface of the bottom surface of the improved air bearing and then stitch the perimeter material onto the bottom surface, wherein the stitching is embedded in the groove or trench. This causes the stitching to be more durable, especially for situations where the stitching might be exposed to abrasion. This method of attachment can be used when attaching other surfaces.

If the perimeter material were a strong elastic material, then the elastic members may be unnecessary on the improved air bearing. The perimeter material can be made of rubber, cotton canvas, polymer, or leather.

The bottom surface of the improved air bearing is a planar horizontal surface, having one or more vertical orifices. The vertical orifices of the bottom surface of the improved air bearing extend completely through the planar horizontal surface of the bottom surface. The bottom surface of the improved air bearing will generally have a multitude of orifices spaced out in a pattern that occupies the entire planar horizontal surface of the bottom surface of the improved air bearing.

The bottom surface of the improved air bearing may have one or more attachment sites. The bottom end of the perimeter material of the inflatable chamber is attached to the bottom surface of the improved air bearing. A flexible bottom surface is a preferred feature.

The bottom surface of the improved air bearing can be made of tetrafluoroethane, another polymer, fiberglass, metal, or composites. Metal is not a preferred material for the bottom surface. The entire bottom surface of the improved air bearing is vertically displaceable. This is a unique feature that makes the improved air bearing a preferable feature on the sliding loader, especially for embodiments that have undercarriage wheels.

The elastic members of the improved air bearing are elastic strings, elastic fibers, metal springs, elastic ropes, elastic material, or elastic straps. The elastic members of the improved air bearing have a top end and a bottom end. The top ends of the elastic members are attached to or near the top surface of the improved air bearing.

The top ends of the elastic members may be attached to the perimeter material of the inflatable chamber near the top end of the perimeter material of the inflatable chamber. The elastic members can be made of rubber, polymer, bungee cords, bungee material, or can be metal springs.

The bottom ends of the elastic members are attached to or near the bottom surface of the improved air bearing. The bottom ends of the elastic members may be attached to the perimeter material of the inflatable chamber near the bottom end of the perimeter material of the inflatable chamber. The bottom ends of the elastic members may be attached to the bottom framework of the improved air bearing. The elastic members may be attached to the bottom framework, bottom surface, perimeter material, or top surface of the improved air bearing using stitching, eye bolts and nuts, knots, glue, clamps, bolts, screws, or any combination thereof.

A preferred method of attachment of the elastic members would be to incorporate nylon, leather, or heavy canvas straps between the perimeter material of the inflatable chamber and the other desired surface, and then stitch the straps to both surfaces. The elastic members can be stitched to the straps. Also, the straps can be folded at the ends and stitched to make a loop. The resulting loop in the straps can serve as another kind of attachment site for the elastic members. The straps can be used in situations where a bottom framework does not exist or where one or more surfaces are less durable than desired.

The bottom framework of the improved air bearing is a horizontally disposed frame, framework, or porous plate. The bottom framework is attached to the bottom surface of the improved air bearing. The bottom framework of the improved air bearing may have one or more attachment sites. The bottom framework of the improved air bearing can be made of metal, composite, polymer, or wood.

The bottom framework of the improved air bearing can be a rectangular frame that surrounds the horizontal perimeter of the bottom surface of the improved air bearing. The bottom framework of the improved air bearing provides structural support for the bottom surface of the improved air bearing and can serve as an attachment site for the elastic members of the improved air bearing. The bottom framework is especially desirable for supporting a bottom surface of the improved air bearing that is made of less durable materials.

The bottom framework of the improved air bearing can be attached to the bottom surface of the improved air bearing using screws, bolts and nuts, glue, pins and clips, or ledges that engage the opposing structural surface. The attachment sites on the various components of the improved air bearing can be hooks, orifices, prongs, clamps, or grooves in the surface that can receive stitching.

The vacuous space of the inflatable chamber is continuous with the orifices of the top surface of the improved air bearing. When pressurized air enters the orifices of the top surface of the improved air bearing, the pressurized air fills the vacuous space within the inflatable chamber.

When pressurized air enters the inflatable chamber of the improved air bearing, the inflatable chamber lengthens vertically, lowers the bottom surface of the improved air bearing, and stretches the elastic members, if present, of the improved air bearing. When the air pressure inside the inflatable chamber decreases below a certain pressure, the elastic members, if present, pull upward on the bottom surface of the improved air bearing to raise the bottom surface of the improved air bearing. If the perimeter material of the inflatable chamber was elastic, then the perimeter material would pull upward on the bottom surface of the improved air bearing.

The preferred vertical dimension on the inflatable chamber of the improved air bearing is less than two inches. The preferred vertical dimension on the bottom surface of the improved air bearing is less than a half of an inch. A short version of the improved air bearing is expected to function better than a much taller version. The horizontal surfaces of the improved air bearing can have many different sizes and shapes.

The forced air means provides pressurized air to the air bearings. The forced air means may provide air to other devices on the sliding loader. The forced air means may provide air to a pneumatic actuator to power the lifting means of the sliding loader, thus making a separate power supply means optional. The forced air means, if it pressurizes fluid, may provide fluid to a hydraulic actuator to power the lifting means of the sliding loader, thus making a separate power supply means optional.

A lifting means is any means for moving payloads in any direction relative to the position of the undercarriage. The lifting means comprises a payload carrier, a positional apparatus, and a powering means, wherein the payload carrier holds, engages, or controls the payload, the positional apparatus is an apparatus for changing the position of the payload carrier relative to a fixed point on the sliding loader, and the powering means forcefully changes the position of the payload carrier by moving certain components of the positional apparatus. Actuators are devices for moving or controlling something.

The lifting means can have different types of payload carriers, such as a bucket, a fork, a scoop, a prong, a hoist, a hook, a forklift, a point, or a platform. The positional apparatus for the lifting means can have a front end loader configuration, a forklift configuration, a hoist configuration, a three point hitch configuration, an elevator configuration, or any extendable, either vertically or horizontally, version of these configurations, such as a horizontally extendable forklift configuration, an extendable hoist configuration that can extend the hoist, or an extendable front end loader configuration. A powering means is any means of moving a device or apparatus.

The powering means of the lifting means is usually an actuator. The powering means can be a hydraulic actuator, a power jack means, a winch, a pneumatic actuator, a solenoid actuator, a mechanical actuator, an electromagnetic actuator, or an electromechanical actuator. One or more actuators can be the powering means for the lifting means. The forced air means may provide power to actuate the actuators on a lifting means.

Winches pulling on cables, ropes, or belts; hydraulic actuators with pistons; pneumatic actuators with pistons; mechanical jacks powered by electric motors; solenoid actuators; and mechanical jacks powered manually can be used as powering means on the lifting means. The lifting means are usually attached to the undercarriage.

The seat for the operator can be any type of seat. Bench seats, bucket seats, seats with side rails, seats with backs, seats with folding backs that fold into a horizontal position, and seats with legs can be used. A seat with a folding backrest is preferable. The folding backrest can be folded into a more compact space for easier transport. A bench type of seat with substantial lateral sides will make it easier for the operator to maneuver some embodiments of the sliding loader with their legs.

A power cable is any wire, cable, electrically conductive material, or any insulated wire, cable, or electrically conductive material. Some of the power cables have multiple wires within the power cable. The control box is a set of switches, usually a multichannel device, for sending or discontinuing electrical power through a power cable.

The handles of the sliding loader may be positioned in different places on the sliding loader. The handles are an additional point of contact for the operator to control the sliding loader. A preferable feature is to have the handles placed high on a stationary portion of the front lifting means, thus allowing the operator to better control the horizontal motion of the front lifting means relative to the body of the sliding loader.

A duct is any hose, conduit, pipe, gas line, fluid line, hydraulic hose, or tube. Ducts can be used to supply pressurized air to the air bearings and to any other air consuming device from the forced air means. Hydraulic hoses are flexible tubing that conveys pressurized hydraulic fluid from one site to another site.

The various components of the sliding loader can be attached to each other or to the undercarriage using bolts and nuts, pins and clips, by welding, rivets, screws, or clamps. There are many different ways of attaching components together.

A “kit” is a grouping of components, whether packaged, assembled, or available together, that can be used to make a sliding loader. A kit may have an undercarriage having a top side, a bottom side, a left side, a right side, a front end, and a rear end; one or more air bearings having a top side and a bottom side, wherein the top sides of the air bearings can be attached to the bottom side of the undercarriage; one or more lifting means, wherein the lifting means can be attached to the undercarriage; and one or more forced air means, wherein the forced air means can be attached to the air bearings to provide pressurized air to the air bearings.

There are many different kinds of undercarriage wheels. The undercarriage wheels are optional. The wheels of the undercarriage wheels should descend to a position below the bottom side of the undercarriage.

Wheels rotationally attached to horizontal axles wherein the wheels extend below the bottom side of the undercarriage would be a functional design of undercarriage wheels, wherein the horizontal axles are attached to the undercarriage. A preferable design of undercarriage wheels would be wheels rotationally attached to the end of castered shanks, wherein the shank portion of the castered shanks fits vertically into vertical holes drilled in the bottom side of the undercarriage, wherein the castered shanks can be rotatably fastened into place, wherein the wheels rotate on a horizontal axis, wherein the shanks of the castered shanks rotate on a vertical axis within the holes drilled in the undercarriage. The wheels attached to castered shanks would be a preferred design.

Another preferred design of undercarriage wheels would be to have the wheels rotationally attached to the end of shanks that are actuated by actuators to make the shanks and the wheels vertically displaceable below the bottom side of the undercarriage. These shanks could be part of the actuator, wherein the actuator is attached to the undercarriage. A solenoid actuator is a preferred actuator to use with the vertically displaceable undercarriage wheels.

A preferred design would be to incorporate the castered wheel design and the actuated design into the same embodiment. These undercarriage wheels would be multidirectional and be actuated to make them vertically displaceable below the bottom side of the undercarriage. Undercarriage wheels can be manually extendable below the bottom side of the undercarriage by having the length of the shafts that are associated with the undercarriage wheels adjustable vertically that are connected to the wheels of the undercarriage wheels.

The undercarriage wheels can be made just long enough to extend below the bottom of the undercarriage and, yet, short enough that they do not extend to the underlying surface when the air bearings, using the bulging type of air bearings or the improved air bearings, are inflated with air during use. This keeps the sliding loader sliding on the underlying surface during use and provides wheel support should the air bearings unexpectedly deflate.

This design can be used with a braking system so that if the brakes are engaged, the rotation of the undercarriage wheels is halted by the brakes, a switch on the brakes causes the forced air means to discontinue providing pressurized air, and the air bearings deflate from lack of pressurized air. A different variation would be to have a brake pedal with a switch so that when the brake pedal is pushed by the operator, the brakes halt the undercarriage wheels while the switch automatically discontinues the forced air means which deflates the air bearings.

Motors are optional. The motors can be AC/DC motors, turbines, or internal combustion engines. These motors can be used to operate fans, pumps, blowers, braking systems, or wheels.

There are many different possible power supply means for the sliding loader. The optional power supply means can be an AC power cord, batteries, fuel cells, solar cells, AC/DC power from a generator that is powered by an internal combustion engine, pressurized gas or fluid from the forced air means, or manual power. These power supply means may provide power to the lifting means, an actuator, a winch, a hydraulic actuator, an electromechanical actuator, a mechanical actuator, a pneumatic actuator, or any device needing power.

The power supply means may provide power to certain optional personal devices, such as a fan for cooling the operator, a mister for cooling the operator, or radio. Electric power and electric signals can be transferred by electric wires, power cables, or electric wires or power cables within conduits.

The control box, shown in some embodiments, can be used to control most of the features of the embodiments. The control box can control the forced air means, by increasing or decreasing the air flow; the lifting means, by causing either vertical or horizontal movement of the positional apparatus of the lifting means relative to the position of the undercarriage; personal comfort devices; brakes; pressure release valves; and air flow regulators associated with the forced air means or any duct systems.

Pressure release valves are devices for decreasing air pressure by releasing air quickly from associated devices. Pressure release valves can be installed within the forced air means, duct system, or air bearings to release air pressure whenever desired. Pressure release valves are optional.

An air flow regulator is any device that regulates air flow. Air flow regulators are optional. Air flow regulators can be air valves, pressure regulators, a baffle system that obstructs air flow within a chamber, or clamping devices that crimp a flexible hose to diminish air flow. The forced air means or the duct system of the various embodiments can have air flow regulators installed. The air flow regulators could be manually controlled or automatically controlled through the control box.

In FIG. 1, embodiment 100 has an undercarriage 136; air bearings (front air bearing 112A and back air bearing 112B, collectively 112); a seat 106 for the operator; a battery 121; battery terminal connectors (positive terminal 157A and negative terminal 157B, collectively 157); a blower 118; blower supports (front blower support 182A and back blower support 182B, collectively 182); pipe supports (front pipe support 170A and back pipe support 170B, collectively 170); a duct system (first pipe 133A, T-pipe 133B, second pipe 133C, elbow pipe 133D, front air bearing pipe 133E (not visible and not labeled), back air bearing pipe 133F (not labeled), collectively 133); a winch 109; winch supports (right winch support 172A and left winch support 172B, collectively 172); a winch cable 115; a cable pulley 124 (partially visible); a winch cable connector 154 (not labeled and not visible); a forklift hook 151 (not labeled and not visible); a control box 148; a control box power cable 139; a winch power cable 145; a blower power cable 142; operator control handles (right control handle 130A and left control handle 130B, collectively 130); vertical supports (right vertical support 127A and left vertical support 127B, collectively 127); a horizontal pulley support 169; vertical channels (right vertical channel 163A (partially visible) and left vertical channel 163B, collectively 163); channel wheels (top right channel wheel 160A (not visible and not labeled), bottom right channel wheel 160B (not visible and not labeled), top left channel wheel 160C, and bottom left channel wheel 160D, collectively 160); two horizontal axles (top horizontal axle 166A and a bottom horizontal axle 166B, collectively 166); a forklift axle attachment block 178 (partially visible); a forklift base plate 175 (partially visible); and payload forks (right payload fork 103A and left payload fork 103B, collectively 103).

The undercarriage 136 is a flat frame that is disposed horizontally. The undercarriage 136 has two vertical orifices (not labeled and not visible) that extend completely through the undercarriage. The undercarriage 136 has a front end, a back end, a left side, a right side, a top side, and a bottom side.

The seat 106 is a seat for the operator. The seat 106 is a bench type seat having a planar surface disposed horizontally and having four legs that extend downward from the planar surface. The bottom ends of the legs of the seat 106 are attached to the top side of the undercarriage 136.

The seat 106 is positioned near the back of the undercarriage. The seat 106 faces gantry-forklift lifting means (not labeled). The seat 106 should be positioned on the sliding loader to allow the operator easy physical access to the operator control handles 130 and the control box 148.

The seat 106 can be a flat bench seat, shallow bucket seat, or a stool. The seat can have a back rest or a folding back rest that folds into a horizontal position. The seat 106 may have side elements to comprise a vertical surface for the operator's legs to push against with the underlying surface.

The vertical orifices of the undercarriage 136 comprise a front vertical orifice (not labeled and not visible) and a back vertical orifice (not labeled and not visible). The front vertical orifice of the undercarriage is positioned directly over the center of the front air bearing 112A. The elbow pipe 133D is directly above the front vertical orifice of the undercarriage 136.

The back vertical orifice (not labeled and not visible) of the undercarriage is positioned directly over the center of the back air bearing 112B (partially visible). The T-pipe 133B is directly above the back vertical orifice (not labeled and not visible) of the undercarriage 136. The vertical orifices (not labeled and not visible) of the undercarriage 136 allow the duct system 133 to convey air to the air bearings 112.

The blower supports 182 are transversely disposed supports having a flat base and a concave upper surface formed by an arc having a longitudinal axis. The axes of the concave upper surfaces of the blower supports 182 aligned longitudinally to form a cradle for supporting the blower 118. The flat bases of the blower supports 182 are attached to the top side of the undercarriage 136 near the back end of the undercarriage and midway between the transverse expanse of the undercarriage 136. The front blower support 182A is forward of the back blower support 182B.

The blower 118 is a motorized fan having a cylindrically shaped outer surface. The blower 118 has an air intake end and an air exit end. The blower 118 is a forced air means. The axis of the cylindrically shaped outer surface of the blower 118 is disposed longitudinally and the cylindrical outer surface of the blower 118 rests in the cradle formed by the concave upper surfaces of the blower supports 182. The blower 118 is attached to the blower supports 182. The blower 118 provides pressurized air to the duct system 133 and any device needing pressurized air.

The pipe supports 170 are transversely disposed supports having a flat base and a concave upper surface formed by an arc having a longitudinal axis. The axes of the concave upper surfaces of the pipe supports 170 aligned longitudinally to form a cradle for supporting the duct system 133. The flat bases of the pipe supports 170 are attached to the top side of the undercarriage 136 near the back end of the undercarriage and midway between the transverse expanse of the undercarriage 136. The front pipe support 170A is forward of the back pipe support 170B.

The duct system 133 is a series of connected ducts that bifurcates into a first branch of ducts and a second branch of ducts. The duct system 133 begins at the first pipe 133A. The first pipe 133A has a first end and a second end and is disposed longitudinally. The first end of the first pipe 133A is attached to the air exit end of the blower 118. The first pipe 133A receives pressurized air from the blower 118.

The second end of the first pipe 133A is attached to T-pipe 133B. The duct system 133 bifurcates at the T-pipe 133B. The first branch of the duct system conveys pressurized air to the front air bearing 112A. The T-pipe 133B has three openings for conveying air.

The first opening of the T-pipe 133B faces backward horizontally. The second opening of the T-pipe 133B faces forward horizontally. The third opening of the T-pipe 133B faces downward vertically.

The first opening of the T-pipe 133B receives pressurized air from the second end of the first pipe 133A. The second opening of the T-pipe 113B is attached to the second pipe 133C. The second pipe 133C has a first end and a second end and is disposed longitudinally. The second opening of the T-pipe 133B conveys pressurized air to the first end of the second pipe 133C. The second pipe 133C is attached to the pipe supports 170. The elbow pipe 133D has a backwards facing horizontal opening and a downwards facing vertical opening. The second end of the second pipe 133C is attached to the backwards facing horizontal opening of the elbow pipe 133D.

The backwards facing horizontal opening of the elbow pipe 133D receives pressurized air from the second pipe 133C. The elbow pipe 133D is attached to the front air bearing pipe 133E (not labeled and not visible). The downwards facing vertical opening of the elbow pipe 133D conveys pressurized air to the front air bearing pipe 133E (not labeled and not visible). The front air bearing pipe 133E (not labeled and not visible) is attached to the front air bearing 112A. The front air bearing pipe 133E (not labeled and not visible) conveys pressurized air to the front air bearing 112A.

The second branch of the duct system 133 conveys pressurized air to the back air bearing 112B. The third opening of the T-pipe 133B is attached to the back air bearing pipe 133F (partially visible and not labeled). The back air bearing pipe 133F is attached to the back air bearing 112B. The back air bearing pipe 133F (partially visible and not labeled) conveys pressurized air to the back air bearing 112B.

The front vertical orifice (not labeled and not visible) of the undercarriage 136 is the orifice through the undercarriage that allows the first branch of the duct system 133 to convey air to the front air bearing 112A. The front vertical orifice of the undercarriage is positioned directly under the elbow pipe 133D. The front air bearing pipe 133E (not labeled and not visible) is positioned vertically within the front vertical orifice of the undercarriage.

The back vertical orifice (not labeled and not visible) of the undercarriage 136 is the orifice through the undercarriage that allows the duct system 133 to convey air to the back air bearing 112B. The back air bearing pipe 133F (partially visible and not labeled) is attached to the third opening of the T-pipe 133B. The back air bearing pipe 133F is positioned vertically within the back vertical orifice of the undercarriage.

The air bearings 112 are planar structures that are disposed horizontally. The air bearings 112 have a top side and a bottom side. The top side of each air bearing 112 is attached to the bottom side of the undercarriage 136. The top side of the air bearing 112 usually receives pressurized air. The air bearings are equipped with an orifice or connector to enable the air bearings to receive pressurized air. The bottom sides of the air bearings usually have a porous, perforated, or open bottom surface that is capable of emitting air.

The bottom side of the air bearings 112 may bulge to form a convex surface on the bottom side, as depicted in FIG. 1, when the air bearings receive air from the blower 118, when activated, via the duct system 133. The bulging action of the bottom side of the air bearing causes the undercarriage 136 to elevate usually several inches from the underlying surface. This emitted air from the bottom surfaces of the air bearings 112 reduces friction between surfaces and allows the sliding loader to slide on some underlying surfaces when a small horizontal force is applied.

The front air bearing 112A provides support for the gantry-forklift lifting means (not labeled) and the front end of the undercarriage 136. The front air bearing 112A receives air from the blower 118 through the duct system 133. The front air bearing 112A is the main bearer of the mass of the payload when the gantry-forklift lifting means is working. The duct system 133 may have an air flow regulator (not included) within the duct system to appropriately adjust the air flow between the two air bearings 112. The T-pipe 133B could be replaced by a bidirectional air flow regulator to achieve air flow regulation between the two air bearings 112.

The back air bearing 112B provides support for the back end of the sliding loader. The back air bearing 112B receives air from the blower 118 through the duct system 133. The back air bearing 112B has a larger bottom surface area than the front air bearing 112B. It is expected that the larger area of the back air bearing 112B will stabilize the body of the sliding loader.

The battery 121 is one or more DC power cells. The battery 121 is a power supply means for embodiment 100. The battery 121 provides power to the various power consuming devices on the sliding loader. The battery 121 could be replaced with an AC power supply, another DC power supply, or an electrical generator powered by an internal combustion engine.

The battery terminal connectors 157 are mechanical contacts connecting the battery terminals to the control box power cable 139. The battery terminal connectors 157 can be a clamp, a bolt that threads into the threaded contact on the battery, a clip, or a vice.

The control box power cable 139, the blower power cable 142, and the winch power cables 145 are wires, insulated wires, or cables that are capable of conducting electrical power. These power cables have a first end and a second end. The first end and the second end of the power cables may split to accommodate multiple connections on each end of the power cable.

The first end of the control box power cable 139 is attached to the battery terminal connectors 157. The second end of the control box power cable 139 is attached to the control box 148. The control box power cable 139 conducts electrical power from the battery 121 to the control box 148.

The control box 148 is a multi-channel power switching device. The control box 148 is attached to the gantry-forklift lifting means (not labeled) and positioned near the control handles 130 to allow the operator easy access to the switches on the control box from the control handles.

The control box 148 has switches that allow the operator to regulate power through different power cables to the various power consuming devices of the sliding loader. The control box 148 could also regulate an air flow regulator (not included) that regulates the pressurized air between the two air bearings 112. The control box 148 sends electrical power through the power cables to control one or more devices on the sliding loader.

The first end of the blower power cable 142 is attached to the control box 148. The second end of the blower power cable 142 is attached to the blower 118. The blower power cable 142 conducts power from the control box 148 to the blower 118. The control box 148 has a switch for regulating power to the blower 118. The operator controls the pressurized air to the air bearings 112 by adjusting the corresponding switch on the control box and by adjusting one or more air flow regulators, if present.

The first end of the winch power cable 145 is attached to the control box 148. The second end of the winch power cable 145 is attached to the winch 109. The control box 148 has a switch for regulating power to the winch 109.

The control handles 130 are handles that are attached to the rearward side of the vertical supports 127. The control handles 130 protrude rearward from the vertical supports 127. The control handles 130 are positioned in easy reach of the operator. The operator controls the motion of the front end of the sliding loader by exerting manual force on the control handles 130.

The gantry-forklift lifting means (not labeled) comprises a powering means, a positional apparatus, and a payload carrier. The powering means is the winch 109. The positional apparatus is the gantry and forklift assembly. The payload carrier is the payload forks 103. The powering means moves components of the positional apparatus and the payload carrier that is attached to the positional apparatus.

The winch 109 is an electromechanical actuator having a revolving cylinder and a cylindrically shaped stationary base end. The winch 109 could be replaced with other actuators. The revolving cylinder of the winch 109 has an attachment site. The stationary base end has a motor for rotating the revolving cylinder of the winch 109. The stationary base of the winch is attached to the gantry of the gantry-forklift lifting means (not labeled).

The winch cable 115 is a rope, a metal cable, a glass cable, a nylon strap, or any other flexible material capable of pulling against heavy forces. The winch cable 115 has a first end, a middle region, and a second end. The first end of the winch cable 115 is attached to the attachment site of the revolving cylinder of the winch 109. The middle region of the winch cable 115 passes through the cable pulley 124. The second end of the winch cable 115 is attached to the forklift assembly (not labeled) of the gantry-forklift lifting means (not labeled).

The winch 109 moves the payload forks 103 of the gantry-forklift lifting means (not labeled) vertically by either extending or retracting the winch cable 115. The winch 109 is an actuator. The operator controls the elevation of the payload forks 103 by moving the corresponding switch on the control box 148. The corresponding switch on the control box allows the operator to raise and lower the payload forks 103.

The gantry (not labeled) comprises the two vertical supports 127 and the horizontal pulley support 169. The two vertical supports 127 are vertical members having a top end, middle region, and bottom end. The bottom end of the right vertical support 127A is attached to the top side of the undercarriage 136 on the right side of the undercarriage 136 near the front end of the undercarriage 136.

The bottom end of the left vertical support 127B is attached to the top side of the undercarriage 136 on the left side of the undercarriage 136 near the front end of the undercarriage 136. The vertical supports 127 are capable of holding up the mass of the gantry-forklift lifting means and suitable payloads on the gantry-forklift lifting means. The gantry (not labeled) can be made to fold or pivot backwards by placing a hinge near the middle or bottom of the gantry. A locking mechanism can be used to lock the folding or pivoting gantry into an operational position.

The horizontal pulley support 169 (not visible and not labeled) is a transversely disposed member having a right end, a middle region, and a left end. The right end of the horizontal pulley support 169 is attached to the top end of the right vertical support 127A. The left end of the horizontal pulley support 169 is attached to the top end of the left vertical support 127B (not visible and not labeled).

The cable pulley 124 (partially visible) is rotationally attached to the middle region of the horizontal pulley support 169. The cable pulley 124 is a pulley that rotates on a horizontal axis disposed transverse to the length of the undercarriage 136. The horizontal pulley support 169 can be viewed in FIG. 1.

The winch base plate 181 is a planar structure positioned vertically and transversely. The winch base plate 181 is attached to the rearward side of the vertical supports 127. The winch base plate 181 is positioned near the middle region of the vertical supports 127.

The winch supports 172 (right winch support 172A and left winch support 172B, collectively 172) are vertically and longitudinally disposed structures having a flat base and a concave opposing surface formed by an arc having a transverse axis. The flat bases of the winch supports 172 are attached to the rearward face of the winch base plate 181. The axes of the concave surfaces of the winch supports 172 are aligned transversely.

The cylindrically shaped stationary base end of the winch 109 is attached to the concave surface of the winch supports 172. The winch 109 can be positioned elsewhere on the sliding loader. The winch 109 can be attached to the undercarriage 136 by using an additional pulley positioned near the bottom of the vertical supports 127.

The second end of the winch cable 115 is attached to the winch cable connector 154 (not labeled and not visible). The winch cable connector 154 is a spliced eye in the end of the cable. The winch cable connector can be a metal ring, a loop, a spliced eye, a hook, a clamp, or clevis.

The forklift hook 151 (not labeled and not visible) is a hook that is attached to the forklift assembly (not labeled) of the gantry-forklift lifting means (not labeled). The forklift hook 151 could be a hook, eye hook, a clamp, a clip, or a clasp. The winch cable connector 154 (not labeled and not visible) connects the winch cable 115 to the forklift hook 151. The winch cable connector 154 can be revocably attached to the forklift hook 151 (not labeled and not visible).

The forklift assembly comprises two vertical channels (right vertical channel 163A and left vertical channel 163B, collectively 163), four channel wheels (top right channel wheel 160A (not labeled and not visible), bottom right channel wheel 160B (not labeled and not visible), top left channel wheel 160C, and bottom left channel wheel 160D, collectively 160), two horizontal axles (top horizontal axle 166A and a bottom horizontal axle 166B, collectively 166), forklift base plate 175, and the forklift axle attachment block 178.

The vertical channels 163 are long structural members that are disposed vertically. The vertical channels 163 have a vertical channel extending the entire length of the structural member. The vertical channels open laterally in one side of the structural member along the entire length of the side. The vertical channels 163 are disposed with the openings of the channels facing each other. The vertical channels 163 have a top end, middle region, and bottom end.

The right vertical channel 163A is attached to the right vertical support 127A. The left vertical channel 163B is attached to the left vertical support 127B. The channels of the vertical channels 163 form a track for the channel wheels 160 to travel vertically along the length of the channel.

The channel wheels 160 are wheels that rotate on a transverse axis within the channels of the vertical channels 163. The channel wheels 160 fit inside the channel of the vertical channels 163. The bottom right channel wheel 160B (not labeled and not visible) is disposed in the bottom of the channel of the right vertical channel 163A. The top right channel wheel 160A (not labeled and not visible) is disposed in the channel of the right vertical channel 163A above the bottom right channel wheel 160B. The bottom left channel wheel 160D is disposed in the bottom of the channel of the left vertical channel 163B. The top left channel wheel 160C is disposed in the channel of the left vertical channel 163B above the bottom left channel wheel 160D.

The horizontal axles 166 are horizontal axles disposed transverse to the length of the undercarriage 136. The horizontal axles 166 have a right end, middle region, and left end. The horizontal axles 166 fit between the two vertical channels 163. The horizontal axles 166 travel on a vertical path. The bottom horizontal axle 166B is disposed between the two vertical channels 163 near the bottom of the vertical channels 163. The top horizontal axle 166A is disposed between the two vertical channels 163 and above the bottom horizontal axle 166B.

The bottom right channel wheel 160B (not labeled and not visible) is rotationally attached to the right end of the bottom horizontal axle 166B. The top right channel wheel 160A (not labeled and not visible) is rotationally attached to the right end of the top horizontal axle 166A. The bottom left channel wheel 160D is rotationally attached to the left end of the bottom horizontal axle 166B. The top left channel wheel 160C is rotationally attached to the left end of the top horizontal axle 166A.

The forklift axle attachment block 178 is member having a right side, a left side, a top end, a bottom end, a front side, and a back side. The forklift axle attachment block 178 is positioned forward of the horizontal axles 166. The bottom horizontal axle 166B is attached near the bottom end of the back side of the forklift axle attachment block 178.

The top horizontal axle 166A is attached to the back side of the forklift axle attachment block 178 at a position on the forklift axle attachment block 178 above the attachment of the bottom horizontal axle 166B to the forklift axle attachment block 178. The top horizontal axle 166A is parallel with the bottom horizontal axle 166B.

The forklift base plate 175 is a member disposed on a vertical plane that is transverse to the length of the undercarriage 136 and forward of the vertical supports 127. The forklift base plate 175 has a right side, a middle portion, a left side, a top end, a bottom end, a front side, and a back side. The front side of the forklift axle attachment block 178 is attached to the back side of the forklift base plate 175.

The payload forks (right payload fork 103A and left payload fork 103B, collectively 103) are structural components having a right angle. The right payload fork 103 has a vertical member and a horizontal member. The vertical members have a top end and a bottom end. The horizontal members are disposed longitudinally and horizontally. The horizontal members have a front end and a back end.

The bottom end of the vertical member of the right payload fork 103A is attached to the back end of the horizontal member of the right payload fork 103A. The horizontal member of the right payload fork 103A extends longitudinally forward of the undercarriage 136. The vertical member of the right payload fork 103A extends vertically upward from the undercarriage 136. The right payload fork 103A is disposed on the right side of the sliding loader.

The left payload fork 103 has a vertical member and a horizontal member. The vertical members have a top end and a bottom end. The horizontal members are disposed longitudinally and horizontally. The horizontal members have a front end and a back end.

The bottom end of the vertical member of the left payload fork 103B is attached to the back end of the horizontal member of the left payload fork 103B. The horizontal member of the left payload fork 103A extends longitudinally forward of the undercarriage 136. The vertical member of the left payload fork 103A extends vertically upward from the undercarriage 136. The left payload fork 103A is disposed on the left side of the sliding loader.

The back side of the vertical member of the right payload fork 103A is attached to the right side of the front side of the forklift base plate 175. The back side of the vertical member of the left payload fork 103B is attached to the left side of the front side of the forklift base plate 175.

The payload forks 103 are attached to the forklift assembly. The forklift axle attachment block 178 extends the payload forks 103 to a position forward of the undercarriage 136.

The embodiment 100 has no driving features to cause horizontal movement of the sliding loader. Horizontal movement of the sliding loader is achieved by the leg strength of the human operator. The air being emitted from the bottom surfaces of the air bearings 112 reduce friction and allow the sliding loader to be slid horizontally with very little force from the human operator, even when the sliding loader is carrying several hundred pounds of payload. Embodiment 100 gives the human operator much control over the horizontal motion of the sliding loader.

In FIG. 2, embodiment 200 of the invention has an undercarriage 236; a seat 206 for the operator; a forced air duct 233; an air bearing 212; a battery 221; a battery power cable 254; two vertical posts (right vertical post 227A and left vertical post 227B, collectively 227); a horizontal pivot support 245; two pivoting arms (right pivoting arm 230A and left pivoting arm 230B, collectively 230); a scoop support 209; a scoop 203; scoop tilt supports (right scoop tilt support 281A and left scoop tilt support 281B, collectively 281); a scoop pivot pin 215; two scoop tilt posts (right scoop tilt post 239A and left scoop tilt post 239B, collectively 239); a horizontal actuator support 266 (partially visible); a horizontal pivoting sleeve 242; a scoop hydraulic actuator 287; actuator supports (right actuator support 284A and left actuator support 284B, collectively 284); an elevating pivot pin 224; an elevating hydraulic actuator 218; pump supports (right pump support 290A and left pump support 290B (not visible and not labeled), collectively 290); a hydraulic fluid pump 251; elevating hydraulic hoses (front elevating hydraulic hose 260A and a back elevating hydraulic hose 260B, collectively 260); bucket tilt hydraulic hoses (front bucket tilt hydraulic hose 263A and back bucket tilt hydraulic hose 263B, collectively 263); a control box power cable 257; and a control box 248. The reference number 5 in FIG. 2 with an arrow next to the “5” refers to and points toward a forced air supply that provides pressurized air to embodiment 200 through the forced air duct 233. The pressurized air is supplied to embodiment 200 by an onsite forced air supply that is separate from embodiment 200.

The undercarriage 236 is a flat plate disposed in a horizontal plane. The undercarriage 236 has a front end, a back end, a left side, a right side, a top side, and a bottom side. The undercarriage 236 has a vertical orifice (not labeled and not visible) that extends completely through the undercarriage 236. The vertical orifice is positioned in the middle of the transverse expanse of the undercarriage and in the middle of the longitudinal expanse of the undercarriage 236.

The seat 206 is a bench type seat having a planar surface disposed horizontally and having four legs that extend downward from the planar surface. The bottom ends of the legs of the seat 206 are attached to the top side of the undercarriage 236. The seat 206 is positioned near the back region of the undercarriage. The seat 206 is a place for the operator to sit while operating the sliding loader 200.

The forced air duct 233 is a flexible duct having a first open end and a second open end. The first open end of the forced air duct 233 is attached to the air emitting orifice of an onsite forced air supply (not labeled and not shown). The reference number 5 in FIG. 2 has an arrow beside it pointing in the direction of the first open end of the forced air duct and the forced air supply (not labeled and not shown).

The forced air duct 233 is disposed horizontally. The forced air duct 233 is the forced air means of embodiment 200. The forced air duct 233 bends as it interacts with other structural elements on the sliding loader. The forced air duct 233 lies on the top side of the undercarriage 236. The second open end of the forced air duct 233 goes through the vertical orifice (not labeled and not visible) of the undercarriage 236.

The air bearing 212 is a planar structure that is disposed horizontally. The air bearing 212 has a top side and a bottom side. The top side of the air bearing 212 usually has a flat top surface. The top side of the air bearing is attached to the bottom side of the undercarriage. The top side of the air bearing usually has an orifice or mouth for receiving pressurized air.

The orifice of the air bearing 212 is positioned directly under the vertical orifice (not labeled and not visible) of the undercarriage 236. The second open end of the forced air duct 233 is attached to the orifice on the top side of the air bearing 212. The forced air duct 233 provides pressurized air to the air bearing 212.

The bottom side of the air bearing 212 usually has a porous, perforated, or open bottom surface that is capable of emitting air. The pressurized air from the forced air duct 233 travels through the top side of the air bearing and enters the bottom side of the air bearing 212 where it forcefully exits the bottom side of the air bearing 212. The pressurized air entering the air bearing 212 causes the bottom side of some types of air bearings to bulge downward, as depicted in FIG. 2.

The bulging action of the bottom side of the air bearing causes the undercarriage 236 to elevate usually several inches from the underlying surface. The air bearing 212 supports the entire weight of the sliding loader and any payload that is being carried on the lifting means.

The battery 221 is a DC power cell. The battery 221 is a power supply means for embodiment 200. The battery 221 provides power to the various power consuming devices on the sliding loader. The battery 221 could be replaced with an AC power supply, another DC power supply, or an electrical generator powered by an internal combustion engine.

The battery 221 is disposed on the top surface of the undercarriage 236 in front of the vertical orifice (not labeled and not visible) of the undercarriage. The battery 221 has positive (not labeled) and negative terminals (not visible and not labeled). One of the battery terminals is depicted in FIG. 2.

The battery power cable 254 is a set of wires or insulated wires. The battery power cable 254 has a first end and a second end. The first end and the second end of the battery power cable may split to accommodate multiple connections on each end of the power cable.

The first end of the battery power cable 254 separates into two wires with each wire having a battery terminal connector (not labeled). The battery terminal connectors on the separated first end of the battery power cable 254 are attached to the terminals of the battery 221.

The second end of the battery power cable 254 is attached to the hydraulic fluid pump 251. The battery power cable 254 conducts electrical power from the battery 221 to the hydraulic fluid pump 251.

Embodiment 200 has a front end loader lifting means (not labeled). The front end loader lifting means (not labeled) comprises a positional apparatus, a payload carrier, and two powering means. The positional apparatus is a front end loader assembly (not labeled).

The payload carrier is the scoop 203. The two powering means are the elevating hydraulic actuator 218 and the scoop hydraulic actuator 287. The scoop 203 will be described with the description of the front end loader assembly (not labeled). The scoop hydraulic actuator 287 will be described after the front end loader assembly.

The front end loader assembly (not labeled) is disposed above the undercarriage 236 on the front half of the undercarriage 236. The front end loader assembly comprises two vertical posts 227, a horizontal pivot support 245, two pivoting arms 230, a scoop support 209, scoop tilt posts 239, a horizontal actuator support 266, and a horizontal pivoting sleeve 242. The scoop 203 will be described after the scoop support 209 and before the scoop tilt posts 239.

The vertical posts 227 are members that are disposed vertically above the undercarriage 236. The vertical posts 227 have a top end, a middle region, and a bottom end. The bottom end of the right vertical post 227A is attached to the right side of the undercarriage 236 near the middle of the longitudinal expanse of the undercarriage. The bottom end of the left vertical post 227A is attached to the left side of the undercarriage 236 near the middle of the longitudinal expanse of the undercarriage.

The horizontal pivot support 245 is a member that is disposed transversely between the top ends of the two vertical posts 227. The horizontal pivot support 245 has a right end and a left end. The right end of the horizontal pivot support 245 is attached to the top end of the right vertical post 227A. The left end of the horizontal pivot support 245 is attached to the top end of the left vertical post 227A.

The pivoting arms 230 are members that are disposed in a longitudinal and vertical plane above the undercarriage 236. The pivoting arms 230 have a front end, a middle region, and a back end. The front ends of the pivoting arms 230 have a transverse orifice extending completely through the pivoting arms.

The back ends of the pivoting arms 230 have a transverse orifice extending completely through the pivoting arms. The right end of the horizontal pivot support 245 occupies the transverse orifice of the back end of the right pivoting arm 230A. The left end of the horizontal pivot support 245 occupies the transverse orifice of the back end of the left pivoting arm 230B. The pivoting arms 230 pivot on a transverse axis and have a vertical path of movement. The pivoting arms 230 are parallel to each other.

The scoop support 209 is a member disposed transversely above the undercarriage 236. The scoop support 209 has a right end, a middle region, and a left end. The right end of the scoop support 209 occupies the transverse orifice of the front end of the right pivoting arm 230A.

The left end of the scoop support 209 occupies the transverse orifice of the front end of the left pivoting arm 230B. The left end of the scoop support 209 protrudes leftward from the left pivoting arm 230B. The right end of the scoop support 209 protrudes rightward from the right pivoting arm 230A.

The scoop 203 is a scoop having a bottom side, a right vertical side, a left vertical side, a top side, and a back side. The bottom side of the scoop 203 is a planar structure having a right end, a left end, a front end, and a back end. The right vertical side of the scoop 203 is a planar structure having a top end, a bottom end, a front end, and a back end. The bottom end of the right vertical side of the scoop 203 is attached to the right end of the bottom side of the scoop.

The right vertical side of the scoop 203 has a transverse and horizontal orifice extending completely through the right vertical side of the scoop on the back end of the right vertical side of the scoop. The left vertical side of the scoop 203 is a planar structure having a top end, a bottom end, a front end, and a back end. The bottom end of the left vertical side of the scoop 203 is attached to the left end of the bottom side of the scoop.

The left vertical side of the scoop 203 has a transverse and horizontal orifice extending completely through the left vertical side of the scoop on the back end of the left vertical side of the scoop. The left end of the scoop support 209 occupies the orifice of the left vertical side of the scoop 203. The right end of the scoop support 209 occupies the orifice of the right vertical side of the scoop 203.

The top side of the scoop 203 is a planar structure having a front end, a back end, a right end, a left end, and a middle region between the left end and the right end. The right side of the top side of the scoop 203 is attached to the top side of the right vertical side of the scoop. The left side of the top side of the scoop 203 is attached to the top side of the left vertical side of the scoop.

The back side of the scoop 203 is a planar structure having a right end, a left end, a top end, and a bottom end. The bottom end of the back side of the scoop 203 is attached to the back end of the bottom side of the scoop. The top end of the back side of the scoop 203 is attached to the back end of the top side of the scoop.

The right side of the back side of the scoop 203 is attached to the right vertical side of the scoop near the back end of the right vertical side of the scoop 203 but in front of the orifice of the right vertical side of the scoop. The left side of the back side of the scoop 203 is attached to the left vertical side of the scoop near the back end of the left vertical side of the scoop 203 but in front of the orifice of the left vertical side of the scoop. The top end of the back side of the scoop 203 is attached to the back end of the top side of the scoop.

The back side of the scoop 203 is in front of the scoop support 209. The scoop 203 pivots on a transverse axis and moves on a vertical path. The scoop 203 has a forward facing opening for receiving a payload and five sides to maintain the payload within the scoop while carrying.

The right scoop tilt support 281A is a planar structure that is disposed in a vertical and longitudinal plane. The right scoop tilt support 281A has a transverse orifice that extends completely through the planar structure of the scoop tilt support. The right scoop tilt support 281A has a top side and a bottom side.

The left scoop tilt support 281B is a planar structure that is disposed in a vertical and longitudinal plane. The left scoop tilt support 281B has a transverse orifice that extends completely through the planar structure of the scoop tilt support. The left scoop tilt support 281B has a top side and a bottom side.

The orifice of the right scoop tilt support 281A is aligned with the orifice of the left scoop tilt support 281B. The right scoop tilt support 281A is separated from the left scoop tilt support 281B. The bottom side of the right scoop tilt support 281A is attached to the right side of the middle region of the top side of the scoop 203.

The right scoop tilt support 281A projects upward from the top side of the scoop 203. The bottom side of the left scoop tilt support 281B is attached to the left side of the middle region of the top side of the scoop 203. The left scoop tilt support 281B projects upward from the top side of the scoop 203.

The scoop pivot pin 215 is a cylindrical member that is disposed transversely.

The scoop pivot pin 215 has a right end, a middle region, and a left end. The right end of the scoop pivot pin 215 occupies the transverse orifice of the right scoop tilt support 281A. The left end of the scoop pivot pin 215 occupies the transverse orifice of the left scoop tilt support 281B. The scoop pivot pin 215 pivots within the transverse orifices of the scoop tilt supports 281.

The right scoop tilt post 239A is a member having a top end and a bottom end.

The bottom end of the right scoop tilt post 239A is attached orthogonally to the upper surface of the middle region of the right pivoting arm 230A. The right scoop tilt post 239A has a transverse orifice that extends completely through the member near the top end of the right scoop tilt post.

The left scoop tilt post 239B is a member having a top end and a bottom end. The bottom end of the left scoop tilt post 239B is attached orthogonally to the upper surface of the middle region of the left pivoting arm 230B. The left scoop tilt post 239B has a transverse orifice that extends completely through the member near the top end of the left scoop tilt post. The transverse orifices of the scoop tilt posts 239 are aligned with each other and the scoop tilt posts are parallel.

The horizontal actuator support 266 is a member that is disposed transversely. The horizontal actuator support 266 has a right end, a middle region, and a left end. The right end of the horizontal actuator support 266 occupies the transverse orifice of the right scoop tilt post 239A. The left end of the horizontal actuator support 266 occupies the transverse orifice of the left scoop tilt post 239B.

The horizontal pivoting sleeve 242 is a cylindrical member that is disposed transversely. The horizontal pivoting sleeve 242 has a transverse orifice extending completely through the cylindrical member. The horizontal pivoting sleeve 242 has an outside diameter along the exterior surface of the cylinder and an inside diameter along the interior surface of the orifice. The horizontal pivoting sleeve 242 has a right end, a middle region, and a left end.

The horizontal pivoting sleeve 242 is disposed transversely between the scoop tilt posts 239. The middle region of the horizontal actuator support 266 occupies the transverse orifice of the horizontal pivoting sleeve 242. The right end of the horizontal actuator support 266 occupies the transverse orifice of the right scoop tilt post 239A. The left end of the horizontal actuator support 266 occupies the transverse orifice of the left scoop tilt post 239B. The horizontal pivoting sleeve 242 is capable of pivoting in relation to the horizontal actuator support 266.

The scoop hydraulic actuator 287 is a hydraulic actuator having a body, a displaceable piston on one end, and a body attachment feature on the opposing end of the hydraulic actuator. The displaceable piston of the scoop hydraulic actuator 287 is a cylindrical member having a projecting end and a reservoir end. The reservoir end of the displaceable piston is housed within the body of the hydraulic actuator. The projecting end of the displaceable piston projects from the body of the hydraulic actuator.

The displaceable piston of the scoop hydraulic actuator 287 extends from and retracts within the body of the scoop hydraulic actuator 287. The displaceable piston of the scoop hydraulic actuator is labeled 269 in FIG. 2. The projecting end of the displaceable piston has a transverse orifice extending completely through the cylindrical member near the end of the projecting end of the displaceable piston.

The body attachment feature of the scoop hydraulic actuator is a cylindrical member. The body attachment feature of the scoop hydraulic actuator is attached to the middle region of the horizontal pivoting sleeve 242. The body attachment feature of the scoop hydraulic actuator is labeled 275 in FIG. 2.

The scoop tilt supports 281 are separated by enough distance to allow the projecting end of the displaceable piston of the scoop hydraulic actuator 287 to fit between the scoop tilt supports 281. The middle region of the scoop pivot pin 215 occupies the transverse orifice of the projecting end of the displaceable piston of the scoop hydraulic actuator 287. The displaceable piston of the scoop hydraulic actuator 287 extends or retracts when there is flow of pressurized hydraulic fluid within the body of the scoop hydraulic actuator. When the displaceable piston of the scoop hydraulic actuator 287 extends or retracts, the scoop 203 pivots on a transverse axis.

The actuator supports 284 are planar structures disposed vertically and longitudinally above the undercarriage 236. The actuator supports 284 have a transverse orifice that extends completely through the planar structure of the actuator supports. The actuator supports 284 have a top end, a bottom end, a right side, a middle region between the top end and the bottom end, and a left side.

The orifice of the right actuator support 284A is aligned with the orifice of the left actuator support 284B. The right actuator support 284A is separated from the left actuator support 284B. Near the front end of the undercarriage 236, the bottom side of the right actuator supports 284A is attached to the top side of the undercarriage 236 at a position that is right of the midline of the expanse extending from right to left of the undercarriage 236.

Near the front end of the undercarriage 236, the bottom side of the left actuator support 284A is attached to the top side of the undercarriage 236 at a position that is left of the midline of the expanse extending from right to left of the undercarriage 236.

The elevating pivot pin 224 is a cylindrical member that is disposed transversely. The elevating pivot pin 224 has a right end, a middle region, and a left end. The right end of the elevating pivot pin 224 occupies the transverse orifice of the right actuator support 284A. The left end of the elevating pivot pin 224 occupies the transverse orifice of the left actuator support 284B. The elevating pivot pin 224 pivots within the transverse orifices of the actuator supports 284.

The elevating hydraulic actuator 218 is a hydraulic actuator having a body, a displaceable piston on one end, and a body attachment feature on the opposing end of the hydraulic actuator. The elevating hydraulic actuator 218 is disposed in a plane extending vertically and longitudinally that is near the midline of the expanse extending from right to left of the undercarriage. The displaceable piston of the elevating hydraulic actuator 218 is a cylindrical member having a projecting end and a reservoir end. The reservoir end of the displaceable piston is housed within the body of the hydraulic actuator. The projecting end of the displaceable piston projects from the body of the hydraulic actuator.

The displaceable piston of the elevating hydraulic actuator 218 extends from and retracts within the body of the elevating hydraulic actuator 218. The displaceable piston of the elevating hydraulic actuator is labeled 272 in FIG. 2.

The body attachment feature of the elevating hydraulic actuator 218 is a cylindrical member having a transverse orifice extending completely through the cylindrical member near the end of the body attachment feature that is opposite the projecting end of the hydraulic actuator. The body attachment feature of the elevating hydraulic actuator is attached to the middle region of the horizontal pivoting sleeve 242. The body attachment feature of the elevating hydraulic actuator is labeled 278 in FIG. 2.

The actuator supports 284 are separated by enough distance to allow the body attachment feature 278 of the elevating hydraulic actuator to fit between the actuator supports 284. The middle region of the elevating pivot pin 224 occupies the transverse orifice of the body attachment feature 278 of the elevating hydraulic actuator.

The projecting end of the displaceable piston 272 of the elevating hydraulic actuator has a pipe transversely attached to end of the projecting end of the displaceable piston. The transversely attached pipe on the projecting end of the displaceable piston 272 has an outside diameter and an inside diameter.

The middle region of the scoop support 209 occupies the inside diameter of the transversely attached pipe on the projecting end of the displaceable piston 272. The displaceable piston of the elevating hydraulic actuator 218 extends or retracts when there is flow of pressurized hydraulic fluid within the body of the elevating hydraulic actuator. The transversely attached pipe on the projecting end of the displaceable piston 272 pivots in relation to the scoop support 209.

The right pump support 290A is a planar structure that is disposed in a vertical and longitudinal plane. The right pump support 290A has a transverse orifice extending completely through the planar structure of the right pump support. The right pump support 290A has a top end and a bottom end.

The right pump support 290A is positioned to the right of the midline of the right to left expanse of the undercarriage 236. The bottom end of the right pump support 290A is attached to the top side of the undercarriage 236.

The left pump support 290B (not visible and not labeled) is a planar structure that is disposed in a vertical and longitudinal plane. The left pump support 290B (not visible and not labeled) has a transverse orifice extending completely through the planar structure of the left pump support. The left pump support 290B (not visible and not labeled) has a top end and a bottom end.

The left pump support 290B (not visible and not labeled) is positioned to the left of the midline of the right to left expanse of the undercarriage 236. The bottom end of the left pump support 290B (not visible and not labeled) is attached to the top side of the undercarriage 236. The transverse orifice of the right pump support 290A aligns with the transverse orifice of the left pump support 290B (not visible and not labeled).

A hydraulic fluid pump 251 is a fluid pump that compresses hydraulic fluid to pressurize the hydraulic fluid. The hydraulic fluid pump 251 is disposed transversely above the undercarriage 236. The hydraulic fluid pump 251 has a left end and a right end.

The hydraulic fluid pump 251 has two transverse orifices on the right end of the hydraulic fluid pump 251. The hydraulic fluid pump 251 has two transverse orifices on the left end of the hydraulic fluid pump 251. The hydraulic fluid pump 251 fits within the space between the pump supports 290.

On the right end of the hydraulic fluid pump 251 is a first threaded hole. On the left end of the hydraulic fluid pump 251 is a second threaded hole. The first threaded hole of the hydraulic fluid pump aligns with the second threaded hole of the hydraulic fluid pump. The threaded holes of the hydraulic fluid pump are made to receive threaded bolts. The transverse orifices of the pump supports 290 align with the threaded holes of the hydraulic fluid pump 251. The hydraulic fluid pump 251 is installed by screwing bolts from each end, left and right, through the separate pump supports 290 into the corresponding threaded holes of the hydraulic fluid pump 251.

The hydraulic fluid pump 251 receives electrical power from the battery 221 through the battery power cable 254. Electrical power from the hydraulic fluid pump 251 flows to the control box 248 through the control box power cable 257.

The elevating hydraulic hoses 260 are hydraulic hoses having a first end and a second end. The first ends of the elevating hydraulic hoses 260 are attached to the transverse orifices on the right end of the hydraulic fluid pump 251. The second ends of the elevating hydraulic hoses 260 are attached to the body of the elevating hydraulic actuator 218. The elevating hydraulic hoses 260 convey pressurized hydraulic fluid to the elevating hydraulic actuator 218 from the hydraulic fluid pump 251. The movement of hydraulic fluid within the elevating hydraulic actuator 218 causes the piston 272 to extend or retract.

When the displaceable piston of the elevating hydraulic actuator 218 extends, the scoop support 209 and the scoop 203 raises. When the displaceable piston of the elevating hydraulic actuator 218 retracts, the scoop support 209 and the scoop 203 lowers. The elevating hydraulic actuator 218 controls the elevation of the scoop 203.

The bucket tilt hydraulic hoses 263 are hydraulic hoses having a first end and a second end. The first ends of the bucket tilt hydraulic hoses 263 are attached to the transverse orifices on the left end of the hydraulic fluid pump 251. The bucket tilt hydraulic hoses 263 travel up the right vertical post 227A and then travel forward along the right pivoting arm 230A.

The second ends of the bucket tilt hydraulic hoses 263 are attached to the body of the scoop hydraulic actuator 287. The bucket tilt hydraulic hoses 263 convey pressurized hydraulic fluid to the scoop hydraulic actuator 287 from the hydraulic fluid pump 251. The hydraulic fluid pump 251 conveys pressurized hydraulic fluid through the bucket tilt hydraulic hoses 263 to and from the scoop hydraulic actuator 287. The movement of hydraulic fluid within the body of the scoop hydraulic actuator 287 causes the piston 269 to extend or retract.

When the displaceable piston 269 of the scoop hydraulic actuator 287 extends, the front end of the scoop 203 pivots downward. When the displaceable piston 269 of the scoop hydraulic actuator 287 retracts, the front end of the scoop 203 pivots upward.

The control box power cable 257 is a power cable having multiple wires. The control box power cable 257 has a first end and a second end. The first end of the control box power cable is attached to the hydraulic fluid pump 251. The second end of the control box power cable is attached to the control box 248.

The control box 248 is a multichannel switch for controlling the electrical power going to the moveable aspects of the sliding loader depicted in FIG. 2. The control box 248 is attached near the top end of the right side of the right vertical post 227A. The control box 248 has multiple switches.

The control box 248 receives power through the control box power cable 257. The control box 248 sends electrical power through the control box power cable 257 to control the functioning of the hydraulic fluid pump 251. The electrical power being sent through different wires within the control box power cable 257 from the control box 248 directs the hydraulic fluid pump 251 to convey hydraulic fluid to either or both of the hydraulic actuators on the front end loader.

The lifting means of embodiment 200 has a front end loader configuration. The scoop 203, also known as a loader bucket, is elevated by the elevating hydraulic actuator 218 that is mounted to the undercarriage 236. The scoop is rotated on a horizontal axis by a scoop hydraulic actuator 287 that is attached to the lifting means. The hydraulic actuators and fluid pump could be replaced with pneumatic actuators connected to a forced air means, electromechanical actuators connected to an AC/DC generator, or a mechanical actuator operated manually.

Embodiment 200 is an embodiment of the invention that represents the possibility that pressurized air can be provided to the sliding loader via a duct from a separate forced air supply and that a forced air supply does not have to be on an embodiment of the sliding loader for the sliding loader to function. In FIG. 2, the forced air duct 233 extends off of the page of the drawing figure to connect to an undepicted forced air supply that is located at the work site. The air from the separated and undepicted forced air supply is forcefully supplied to the sliding loader 200 via the forced air duct 233.

In FIG. 3, embodiment 300 has an undercarriage 336; compressed gas vessel 318; a flexible duct 321; an overhead vertical duct 324; a first nontransverse T-pipe 333; an upper horizontal duct 339 (partially visible); an upper horizontal pipe 342 (partially visible); duct supports (front duct support (not labeled and not shown) and back duct support 396B (partially visible), collectively 396); a gas flow regulator 345 (partially visible); a second nontransverse T-pipe 352; a lower horizontal duct 355; a nontransverse elbow pipe 358; a first vertical pipe (not labeled and not shown); a second vertical pipe (not labeled and not shown); two air bearings (front air bearing 312A and back air bearing 312B, collectively 312); a seat 306 for the operator; actuator supports (right actuator support 379A and left actuator support 379B (not labeled and partially visible), collectively 379); a pneumatic actuator pin 384; a pneumatic actuator 309; a control lever 348; two vertical supports (right vertical support 327A and left vertical support 327B, collectively 327); a horizontal support 376; two vertical sleeves (right vertical sleeve 373A and left vertical sleeve 373B (not labeled and partially visible), collectively 373); a piston plate 390; piston receivers (right piston receiver 370A and left piston receiver 370B, collectively 370); a piston pin 381; a vertical platform plate 387; a lifting platform 303; handle supports (top handle support 393A and bottom handle support 393B, collectively 393); and a handle 330 for the operator.

The undercarriage 336 is a planar frame that is disposed horizontally. The undercarriage 336 has two vertical orifices (not labeled and not visible) comprising a front vertical orifice and a back vertical orifice that extend through the undercarriage 336. The undercarriage 336 has a top side, bottom side, a front end, a back end, a right side, and a left side. The undercarriage 336 is the supporting frame to which the other components of embodiment 300 are attached.

The first vertical orifice (not labeled and not visible) of the undercarriage 336 is directly under the nontransverse elbow pipe 358. The second vertical orifice (not labeled) of the undercarriage 336 is directly under the second nontransverse T-pipe 352.

The compressed gas vessel 318 is a pressurized gas cylinder having an air valve 315 and an air emission orifice (not labeled and not visible). The compressed gas vessel 318 has a top end and a bottom end. The air emission orifice (not labeled and not visible) is located at the top end of the compressed gas vessel 318.

The compressed gas vessel 318 is disposed vertically on the back of the top side of the undercarriage 336. The compressed gas vessel 318 is revocably attached to the undercarriage 336. The compressed gas vessel 318 is the forced air means for embodiment 300. The air valve 315 controls the air flow through the air emission orifice (not labeled and not visible).

Embodiment 300 has a branched duct system comprising a first duct system (not labeled) and a second duct system (not labeled). The first duct system comprises the flexible duct 321, the overhead vertical duct 324, the first nontransverse T-pipe 333, the upper horizontal duct 339, and the upper horizontal pipe 342. The flexible duct 321 is a flexible duct having a first end and a second end.

The first end of the flexible duct 321 is attached to the air emission orifice (not labeled and not visible) of the compressed gas vessel 318. The overhead vertical duct 324 is a duct that is disposed vertically near the back end of the undercarriage 336. The overhead vertical duct 324 has a top end and a bottom end. The top end of the overhead vertical duct 324 is attached to the second end of the flexible duct 321.

The first nontransverse T-pipe 333 is a duct having three openings comprising a first opening, a second opening, and a third opening. The first opening is directed upward. The second opening is directed forward. The third opening is directed downward.

The first opening of the first nontransverse T-pipe 333 is attached to the bottom end of the overhead vertical duct 324. The upper horizontal duct 339 is a duct having a first end and a second end. The upper horizontal duct 339 is disposed longitudinally. The first end of the upper horizontal duct 339 is attached to the second opening of the first nontransverse T-pipe 333.

The upper horizontal pipe 342 is a duct having a first end and a second end. The upper horizontal pipe 342 is disposed longitudinally. The first end of the upper horizontal pipe 342 is attached to the second end of the upper horizontal duct 339. The first duct system supplies pressurized air to the pneumatic actuator 309 and the second duct system.

The duct supports 396 are transversely disposed supports having a flat base and a concave upper surface formed by an arc having a longitudinal axis. The axes of the concave upper surfaces of the duct supports 396 are aligned longitudinally to form a cradle for supporting the second duct system. The flat bases of the duct supports 396 are attached to the top side of the undercarriage 336 near the middle of the undercarriage and midway between the transverse expanse of the undercarriage 336. The front duct support 396A (not visible and not labeled) is forward of the back duct support 396B and located near the front of the undercarriage 336.

The second duct system (not labeled) comprises the gas flow regulator 345, the second nontransverse T-pipe 352, the lower horizontal duct 355, the nontransverse elbow pipe 358, the first vertical pipe (not labeled and not shown), and the second vertical pipe (not labeled and not shown). The gas flow regulator 345 is a flow control device having a top end, a valve, and a bottom end. The top end of the gas flow regulator 345 is attached to the third opening of the first nontransverse T-pipe 333.

The second nontransverse T-pipe 352 is a duct having three openings comprising a first opening, a second opening, and a third opening. The first opening is directed upward. The second opening is directed forward. The third opening is directed downward.

The first opening of the second nontransverse T-pipe 352 is attached to the bottom end of the gas flow regulator 345. The lower horizontal duct 355 is a duct having a first end and a second end. The lower horizontal duct 355 is supported by and attached to the duct supports 396. The lower horizontal duct 355 is disposed longitudinally. The first end of the lower horizontal duct 355 is attached to the second opening of the second nontransverse T-pipe 352.

The nontransverse elbow pipe 358 is a duct having a backwards facing horizontal opening and a downwards facing vertical opening. The second end of the lower horizontal duct 355 is attached to the backwards facing horizontal opening of the nontransverse elbow pipe 358. The first vertical pipe (not labeled and not shown) is a duct having a top opening and a bottom opening.

The first vertical pipe (not labeled and not shown) is disposed vertically within the front vertical orifice of the undercarriage 336. The top opening of the first vertical pipe (not labeled and not shown) is attached to the downwards facing vertical opening of the nontransverse elbow pipe 358.

The second vertical pipe (not labeled and not shown) is a duct having a top opening and a bottom opening. The second vertical pipe (not labeled and not shown) is disposed vertically within the back vertical orifice of the undercarriage 336. The top opening of the second vertical pipe (not labeled and not shown) is attached to the third opening of the second nontransverse T-pipe 352.

The air bearings 312 are planar structures that are disposed horizontally. The air bearings 312 have a top side and a bottom side. The top side of each air bearing 312 is attached to the bottom side of the undercarriage 336. The top side of the air bearing 312 usually receives pressurized air. The air bearings are equipped with an orifice or connector to enable the air bearings to receive pressurized air. The bottom sides of the air bearings usually have a porous, perforated, or open bottom surface that is capable of emitting air.

The orifice of the top side of the front air bearing 312A is attached to the bottom opening of the front vertical pipe (not labeled and not visible). The front air bearing 312A receives air from the compressed gas vessel 318 through the duct system. The bottom side of the air bearings 312 may bulge to form a convex surface on the bottom side, as depicted in FIG. 3, when the air bearings receive air from the compressed gas vessel 318.

The orifice of the top side of the back air bearing 312B is attached to the bottom opening of the back vertical pipe (not labeled and not visible). The back air bearing 312B receives air from the compressed gas vessel 318 through the duct system. The bottom side of the air bearings 312 may bulge to form a convex surface on the bottom side, as depicted in FIG. 3, when the air bearings receive air from the compressed gas vessel 318.

The bulging action of the bottom side of the air bearing causes the undercarriage 336 to elevate usually several inches from the underlying surface. The air bearings 312 emit air from the bottom surfaces of the bottom sides of the air bearings. This emitted air from the bottom surfaces of the air bearings 312 reduces friction between surfaces and allows the sliding loader to slide on some underlying surfaces when a small horizontal force is applied.

The seat 306 is a seat for the operator. The seat 306 is a bench type seat having a planar surface disposed horizontally and having four legs that extend downward from the planar surface. The bottom ends of the legs of the seat 306 are attached to the top side of the undercarriage 336.

The seat 306 is positioned near the middle of the undercarriage 336. The seat 306 faces the lifting means (not labeled). The seat 306 should be positioned on the sliding loader to allow the operator easy physical access to the operator control lever 348 and the handle 330.

The seat 306 (not included) can be a flat bench seat, shallow bucket seat, or a stool. The seat can have a back rest or a folding back rest that folds into a horizontal position. The seat 306 may have side elements to comprise a vertical surface for the operator's legs to push against with the underlying surface.

The actuator supports 379 are planar structures disposed in a vertical and longitudinal plane near the front vertical orifice of the undercarriage 336. The actuator supports 379 have a top end and a bottom end. The actuator supports 379 have a transverse orifice extending completely through the planar structure near the top end of the actuator supports. The transverse orifices of the actuator supports 379 are positioned above the lower horizontal duct 355.

The right actuator support 379A is disposed to the right of the lower horizontal duct 355. The bottom end of the right actuator support 379A is attached to the top side of the undercarriage 336.

The left actuator support 379B (not labeled and not visible) is disposed to the left of the lower horizontal duct 355. The bottom end of the left actuator support 379B (not labeled and not visible) is attached to the top side of the undercarriage 336.

The pneumatic actuator pin 384 is a cylindrical member disposed transversely. The pneumatic actuator pin 384 has a left end, a middle region, and a right end. The right end of the pneumatic actuator pin 384 occupies the transverse orifice of the right actuator support 379A. The left end of the pneumatic actuator pin 384 occupies the transverse orifice of the left actuator support 379B (not labeled and not visible).

The pneumatic actuator 309 is a pneumatic actuator having a body, a gas chamber (not individually labeled), a displaceable piston 367, a valve (not labeled and not shown), and a control lever 348. The gas chamber is in the body of the pneumatic actuator 309. The body of the pneumatic actuator 309 has a cylindrical outer surface. The displaceable piston 367 is a cylindrical member that extends from and retracts into the pneumatic actuator.

The displaceable piston 367 is disposed vertically and has a top end and a bottom end. The bottom end of the displaceable piston occupies the body of the pneumatic actuator. The top end of the displaceable piston protrudes upward from the body of the pneumatic actuator 309. The displaceable piston 367 has a transverse orifice extending completely through the cylindrical member of the displaceable piston near the top end of the displaceable piston.

The second end of the upper horizontal pipe 342 is attached to the valve of the pneumatic actuator 309. The upper horizontal pipe 342 provides pressurized air to the valve of the pneumatic actuator 309. The valve of the pneumatic actuator 309 is an air valve that directs the air flow within the pneumatic actuator.

The valve of the pneumatic actuator 309 has a first position, a second position, and a third position. The second position is between the first position and the third position. When the valve is in the first position, the valve causes the displaceable piston 367 to lower. When the valve is in the second position, the valve causes the displaceable piston 367 to remain stationary. When the valve is in the third position, the valve causes the displaceable piston 367 to elevate.

The control lever 348 is a spring loaded lever that controls the positioning of the valve of the pneumatic actuator 309. When the operator pulls the control lever backwards, the valve moves into the first position. When the operator applies no force to the control lever, the force of the spring moves the valve into the second position. When the operator pushes the control lever forwards, the valve moves into the third position.

The lifting means (not labeled) comprises two vertical supports (right vertical support 327A and left vertical support 327B, collectively 327), a horizontal support 376, two vertical sleeves (right vertical sleeve 373A and left vertical sleeve 373B (not labeled and partially visible), collectively 373), a piston plate 390, a piston receiver 370, a piston pin 381, a vertical platform plate 387, and a lifting platform 303. The vertical supports 327 are cylindrical members disposed vertically above the undercarriage 336 near the front end of the undercarriage.

The vertical supports 327 have a top end, a middle region, and a bottom end. The bottom end of the right vertical support 327A is attached to the top side of the undercarriage 336 on the right side of the undercarriage. The bottom end of the left vertical support 327B is attached to the top side of the undercarriage 336 on the left side of the undercarriage.

The horizontal support 376 is a horizontal member having a right end, a middle region, and a left end. The right end of the horizontal support is attached to the top end of the right vertical support 327A. The left end of the horizontal support 376 is attached to the top end of the left vertical support 327B.

The vertical sleeves 373 are circular pipes having an inside diameter and an outside diameter. The vertical sleeves 373 are disposed vertically above the undercarriage 336. The inside diameter of the vertical sleeves are lined with linear bearing material for reducing friction. The vertical sleeves can alternatively be lined with smooth copper surfaces, polymers of tetrafluoroethane, or linear bearings.

The right vertical support 327A occupies the inside diameter of the right vertical sleeve 373A. The left vertical support 327B occupies the inside diameter of the left vertical sleeve 373B (not labeled and partially visible). The right vertical sleeve 373A slides vertically on the right vertical support 327A. The left vertical sleeve 373B (not labeled and partially visible) slides vertically on the left vertical support 327B.

The piston plate 390 is a planar structure disposed in a transverse and vertical plane. The piston plate 390 has a top end, a bottom end, a right side, and a left side. The bottom right side of the piston plate 390 is attached to the rearward side of the right vertical sleeve 373A. The bottom left side of the piston plate 390 is attached to the rearward side of the left vertical sleeve 373B (not labeled and partially visible). The top end of the piston plate 390 narrows to a width that is wider than the width of the displaceable piston 367. When the piston plate 390 and the vertical sleeves 373 are in their lowest position, the top end of the piston plate 390 extends to a level height with the lowest position attainable by the displaceable piston 367 of the pneumatic actuator 309.

The piston receivers 370 are planar structures disposed in a vertical and longitudinal plane. The piston receivers 370 have a front end and a back end. The piston receivers 370 have a transverse orifice extending completely through the planar structures near the back ends of the piston receivers. The transverse orifices of the piston receivers 370 are aligned transversely.

The right piston receiver 370A is positioned to the right of the right side of the displaceable piston 367. The left piston receiver 370B is positioned to the left of the left side of the displaceable piston 367. The front end of the piston receivers 370 are attached to the top end of the piston plate 390.

The piston pin 381 is a cylindrical member disposed transversely. The piston pin 381 has a left end, a middle region, and a right end. The right end of the piston pin 381 occupies the transverse orifice of the right piston receiver 370A. The left end of the piston pin 381 occupies the transverse orifice of the left piston receiver 370B. The middle region of the piston pin 381 occupies the transverse orifice of the displaceable piston 367.

The vertical platform plate 387 is a rectangular plate that is disposed vertically and transversely in front of the vertical sleeves 373. The vertical platform plate 387 has a right side, a left side, a top end, a bottom end, a front side, and a back side. The back side of the right side of the vertical platform plate 387 is attached to the front side of the right vertical sleeve 373A. The back side of the left side of the vertical platform plate 387 is attached to the front side of the left vertical sleeve 373B (not labeled and partially visible).

The lifting platform 303 has a horizontal plate and a vertical plate. The horizontal plate of the lifting platform 303 is disposed horizontally. The vertical plate of the lifting platform 303 is disposed vertically and transversely. The horizontal plate of the lifting platform has a front end and a back end.

The vertical plate of the lifting platform 303 has a top end, a bottom end, a right side, a left side, a front side, and a back side. The back end of the horizontal plate of the lifting platform 303 is attached to the bottom end of the vertical plate of the lifting platform 303. The horizontal plate of the lifting platform 303 extends forward horizontally from the vertical plate of the lifting platform and from the embodiment. The horizontal plate of the lifting platform 303 carries the payload of the lifting means.

The back side of the vertical plate of the lifting platform 303 is attached to the front side of the vertical platform plate 387. When the displaceable piston 367 of the pneumatic actuator changes vertical displacement, the lifting means (not labeled) changes the vertical height of the lifting platform 303.

When the human operator moves the control lever 348 into a first position, the displaceable piston 367 lowers and parts of the attached lifting means (not labeled) are lowered to lower the lifting platform 303 and any payload on the lifting platform. When the human operator moves the control lever 348 into a third position, the displaceable piston 367 extends upward and parts of the attached lifting means (not labeled) are raised to raise the lifting platform 303 and any payload.

The handle supports 393 are planar supports disposed in a longitudinal and horizontal planes. The handle supports 393 have a front side and a back side. The front sides of the handle supports 393 have a concave surface formed by an arc having a vertical axis. The concave surfaces of the front sides of the handle supports 393 have the same radius as the cylindrical outer surface of the body of the pneumatic actuator 309. The back sides of the handle supports 393 have a flat surface and face backwards.

The top handle support 393A is positioned above the bottom handle support 393B. The concave surfaces of the front sides of the handle supports 393 align vertically to form a vertically positioned cradle. The concave surfaces of the front sides of the handle supports 393 are attached to the cylindrical outer surface of the body of the pneumatic actuator 309.

The handle 330 is a planar structure having a top end, a bottom end, a front side, a back side, a right side, a left side, a middle region between the left side and the right side, a top half, and a bottom half. The handle 330 is disposed in a vertical and transverse plane in front of the seat 306 and rearward of the pneumatic actuator 309.

The top half of the handle 330, from left to right, is about the width of the average human palm. The bottom half of the handle 330, from left to right, is broad and has a rectangular shaped longitudinal orifice extending completely through the middle region of the bottom end of the handle 330. The rectangular shaped longitudinal orifice in handle 330 creates a tuning fork-like configuration in the bottom half of the handle 330 having a broad right prong and a broad left prong, wherein the prongs are pointed downward.

The broad right prong of the handle 330 is positioned to the right of the lower horizontal duct 355. The broad left prong of the handle 330 is positioned to the left of the lower horizontal duct 355. The bottom ends of the broad right prong and the broad left prong of the handle 330 are attached to the undercarriage 336. The top side of the rectangular shaped longitudinal orifice of the handle 330 is above the upper horizontal pipe 342.

The front side of the top half of the handle 330 is attached to the flat backwards facing surfaces of the handle supports 393. The handle 330 gives the operator a structural element with which to apply a horizontal force to the sliding loader.

Embodiment 300 can be solely powered by the forced air means. Embodiment 300 may be suitable for use in some explosive or flammable environments.

The lifting means of embodiment 300 is a platform mounted upon two sleeves that slide vertically upon two vertical members with only one sleeve sliding upon one vertical member. The lifting means of embodiment 300 is powered by a pneumatic actuator receiving pressurized air from a compressed gas vessel through a duct system.

In FIG. 4, embodiment 400 of the sliding loader is depicted. Embodiment 400 has an extending hoist lifting means and solenoid actuated vertically displaceable wheels. FIG. 4 depicts a right side and downward perspective view of embodiment 400.

In FIG. 4, embodiment 400 has an undercarriage 436; two air bearings (front air bearing 412A and back air bearing 412B, collectively 412); four solenoid supports (front right solenoid support 422A, front left solenoid support 422B (not labeled and hardly visible), back right solenoid support 422C, and back left solenoid support 422D, collectively 422); four solenoids (front right solenoid 416A, front left solenoid 416B (partially visible), back right solenoid 416C, and back left solenoid 416D, collectively 416); four solenoid wheels (front right solenoid wheel 404A, front left solenoid wheel 404B (not labeled and not visible), back right solenoid wheel 404C, and back left solenoid wheel 404D, collectively 404); a battery 420; two battery terminal connectors (positive terminal connector 456A and negative terminal connector 456B, collectively 456); an operator's seat 406; an upright barrier 408; a hoist base 446; an elevating actuator base 486; back elevating actuator pin 484, a blower 418; blower supports (front blower support 482A and back blower support 482B, collectively 482); a duct system (comprising a back T-pipe 432A, a flexible duct 432B, a front vertical duct 432C (not labeled and not visible), and a back vertical duct 432D (not labeled and not visible), collectively 432); a control box 448; a control box power cable 438; a blower power cable 442; two operator handles (right operator handle 430A and left operator handle 430B, collectively 430); two pump supports (front pump support 426A (not labeled and not visible) and back pump support 426B (not labeled and not visible), collectively 426); a hydraulic pump 424 (partially visible); extending hydraulic hoses (front extending hydraulic hose 428A and back extending hydraulic hose 428B, collectively 428); elevating hydraulic hoses (front elevating hydraulic hose 434A and back elevating hydraulic hose 434B, collectively 434); a pump power cable 414; a solenoid power cable 410; a hoist base pivot pin 444; a hoisting member 450; an elevating hoist connector 452; a front elevating pin 454; an extending hoist connector 458; an elevating hydraulic actuator 478; an extending boom 472; an extending boom connector 470; a boom-hook support 474; a back extending pin 460; a front extending pin 468; an extending hydraulic actuator 464; a hook ring 476; and a payload hook 402.

The undercarriage 436 is a flat frame that is disposed horizontally. The undercarriage 436 has a front end, a back end, a left side, a right side, a top side, and a bottom side. The undercarriage 436 has two vertical orifices (not labeled and not visible) that extend completely through the undercarriage.

The vertical orifices of the undercarriage 436 comprise a front vertical orifice (not labeled and not visible) and a back vertical orifice (not labeled and not visible). The front vertical orifice of the undercarriage is positioned directly over the center of the front air bearing 412A. The back vertical orifice of the undercarriage is positioned directly over the center of the back air bearing 412B and directly under the back T-pipe 432A.

The undercarriage 436 has two threaded holes near each of the four corners of the undercarriage. The axes of the threaded holes of the undercarriage 436 are longitudinal. The threaded holes of the undercarriage 436 are for receiving bolts.

The air bearings 412 are planar structures that are disposed horizontally. The air bearings 412 have a top side and a bottom side. The top side of each air bearing 412 is attached to the bottom side of the undercarriage 436. The top side of the air bearing usually receives pressurized air. The top side of the air bearings is equipped with an orifice or connector to enable the air bearings to receive pressurized air. The bottom sides of the air bearings usually have a porous, perforated, or open bottom surface that is capable of emitting air.

The bottom side of the air bearings 412 may bulge to form a convex surface on the bottom side, as depicted in FIG. 4, when the air bearings receive air. The bulging action of the bottom side of the air bearing causes the undercarriage 436 to elevate usually several inches from the underlying surface. The emitted air from the bottom surfaces of the air bearings 412 reduces friction between surfaces and allows the sliding loader to slide on some underlying surfaces when a small horizontal force is applied.

The front air bearing 412A provides support for the extending hoist lifting means (not labeled) and the front end of the undercarriage 436. The front air bearing 412A is the main bearer of the mass of the payload when the extending hoist lifting means is working.

The back air bearing 412B provides support for the back end of the sliding loader. The back air bearing 412B has a larger bottom surface area than the front air bearing 412B. It is expected that the larger area of the back air bearing 412B will stabilize the body of the sliding loader.

The solenoid supports 422 are structural support blocks that are disposed adjacent to the front and back sides of the undercarriage 436. Each solenoid support has a vertical orifice extending completely through the solenoid support. Each solenoid support has two longitudinal orifices extending completely through the solenoid support. The solenoid supports 422 are attached to the undercarriage 436 with bolts (not labeled) through the longitudinal orifices of the solenoid supports 422 into the threaded holes of the undercarriage 436. The solenoid supports 422 are attached near the four corners of the undercarriage 436.

A solenoid actuated wheel (not labeled) consists of a solenoid 416 and a solenoid wheel 404. The solenoid actuated wheels (not labeled) are disposed vertically. The solenoids 416 are solenoid actuators having a cylindrical outer surface and actuated pistons (not labeled) that extend downward from the cylindrical outer surface. The solenoids 416 can be actuated by AC/DC power. The solenoids 416 have an actuated piston (not labeled) that is vertically displaceable. The actuated piston (not labeled) of the solenoids 416 rotates on a vertical axis.

The solenoids 416 of the solenoid actuated wheels (not labeled) occupy the vertical orifices of the solenoid supports 422. The solenoids 416 have a perimeter lip or edge that extends radially outward from the outer circumference of the solenoid. The perimeter lip (not shown) of the solenoids 416 engages the bottom edge of the solenoid supports 422 to prevent the solenoid actuated wheels (not labeled) from moving upward within the vertical orifice of the solenoid supports 422. The solenoid supports 422 attach the solenoid actuated wheels (not labeled) to the undercarriage 436. The solenoid actuated wheels can also be attached to the solenoid supports 422 by a clamp, pin, thumbscrew type of device, bolt, a clip, or screw.

The solenoid wheels 404 are castered wheels that are attached to the actuated piston of the solenoids 416. The solenoid wheels 404 rotate on a horizontal axis. The castered wheels of the solenoid wheels 404 rotate with the actuated piston (not labeled) of the solenoids 416 on a vertical axis. The caster of the castered wheels is a structural angle that attaches the wheels at an angle to the direction of the actuated piston of the solenoids 416. This structural angle allows the castered wheels to pivot freely on a vertical axis when any horizontal forces are being applied to the sliding loader.

When the solenoids 416 actuate, the solenoid wheels 404 are vertically displaced with the solenoid piston. By actuating the solenoids 416, the operator of the sliding loader vertically displaces the solenoid wheels 404. By extending the solenoid wheels 404, the operator raises the undercarriage 436 relative to the underlying surface and disengages the air bearings 412 from the underlying surface. By retracting the solenoid wheels 404, the operator lowers the undercarriage 436 relative to the underlying surface and engages the air bearings 412 with the underlying surface.

The battery 420 is a DC power cell. The battery 420 is the electrical power supply for the sliding loader. Electrical power can be provided to the sliding loader by any power producing device, including batteries, AC/DC generators powered by internal combustion engines, and AC/DC power cables connected to an AC/DC power source.

The battery terminal connectors 456 are connectors for attaching cables to a battery. There are two battery terminal connectors, a positive battery terminal connector 456A and a negative battery terminal connector 456B.

The battery terminal connectors 456 connect the control box power cable 438 to the battery 420. There are numerous battery terminal connectors. Post battery terminal connectors are used in FIG. 4A. Battery terminal connectors can be clips (clamps operated by springs), bolts that screw into the battery terminal, or clamps operated by bolts.

The operator's seat 406 is a seat for the operator of the sliding loader. The operator's seat 406 has four vertical legs having top ends and a bottom ends; a planar seat that is disposed horizontally having a front end, a back end, a top side, and a bottom side; and a vertical back rest having a top end and a bottom end. The bottom ends of the vertical legs of the operator's seat are attached to the top side of the undercarriage 436. The bottom side of the planar seat is attached to the top ends of the vertical legs of the seat. The bottom end of the vertical back rest is attached to the back of the planar seat.

The operator's seat 406 faces the front of the undercarriage 436. The operator's seat can be a flat bench seat, shallow bucket seat, or a stool. The seat can have a back rest or a folding back rest that folds into a horizontal position. The operator's seat may have side elements to comprise a vertical surface for the operator's legs to push against with the underlying surface. The operator's seat is positioned near the back of the sliding loader.

The upright barrier 408 is a planar structure disposed vertically and transversely to the undercarriage 436. The upright barrier 408 is positioned near the middle of the longitudinal expanse of the undercarriage 436. The upright barrier 408 has a top end, a bottom end, a front side, a back side, a left side, and a right side.

The upright barrier 408 is broad from left to right at the bottom end and narrow from left to right at the top end. The upright barrier 408 has a longitudinal orifice extending completely through the right side of the bottom end of the upright barrier 408. The bottom end of the upright barrier 408 is attached to the top side of the undercarriage 436.

The hoist base 446 is a structural element having a cylindrical base on the bottom end and a nearly rectangular top end. The hoist base 446 has a top end, a bottom end, a left side, and a right side. The bottom end of the hoist base 446 is cylindrical and is positioned in the middle of the transverse expanse of the undercarriage 436. The bottom end of the hoist base 446 is attached to the top side of the undercarriage 436. The top end of the hoist base is shaped nearly rectangular with the long side of the rectangle extending forward and backward and the short side of the rectangle extending laterally from right to left. The rectangular top end of the hoist base 446 has a transverse orifice extending completely through the top end of the hoist base.

The pivot pin 444 is a cylindrical structure that is disposed transversely. The pivot pin 444 has a right end, a left end, and a middle region between the right and left ends. The middle region of the pivot pin 444 occupies the transverse orifice of the hoist base 446. The left end of the pivot pin 444 protrudes out the left side of the top end of the hoist base 446. The right end of the pivot pin 444 protrudes out the right side of the top end of the hoist base 446.

The elevating actuator base 486 is a structural block that is disposed longitudinally and transversely above the undercarriage 436. The elevating actuator base 486 has a front end, a back end, a top side, a bottom side, a right side, and a left side. The structure block of the elevating actuator base 486 has a front top corner that is rounded off to form a 90 degree arc on a transverse axis. This rounded corner of the elevating actuator base 486 allows the elevating hydraulic actuator 478 to pivot upward. The bottom side of the elevating actuator base 486 is attached to the front end and top side of the undercarriage 436. The elevating actuator base 486 has a transverse orifice extending completely through the elevating actuator base.

The back elevating actuator pin 484 is a cylindrical structure that is disposed transversely. The back elevating actuator pin 484 has a right end, a left end, and a middle region between the right and left ends. The middle region of the back elevating actuator pin 484 occupies the transverse orifice of the elevating actuator base 486. The left end of the back elevating actuator pin 484 protrudes out the left side of the elevating actuator base 486. The right end of the back elevating actuator pin 484 protrudes out the right side of the elevating actuator base 486.

The blower supports 482 are transversely disposed supports having a flat base and a concave upper surface formed by an arc having a longitudinal axis. The blower supports 482 are disposed near the back of the sliding loader and midway between the right and left expanse of the undercarriage 436. The blower supports 482 are attached to the undercarriage 436. The concave upper surfaces of the blower supports 482 are aligned longitudinally. The concave upper surfaces of the blower supports 482 form a cradle.

The blower 418 is a cylindrical bodied motorized fan or blower having an air intake end and an air emitting end. The cylindrical body of the blower 418 is disposed longitudinally above the undercarriage 436. The cylindrical body of the blower 418 resides in the cradle formed by the concave upper surfaces of the blower supports 482. The blower 418 is attached to the blower supports 482. The air emitting end of the blower 418 emits air toward the front end of the sliding loader.

The duct system 432 is a bifurcated system of ducts that conveys air from the blower 418 to the air bearings 412. The back T-pipe 432A is a duct having a first opening, a second opening, and a third opening. The back T-pipe 432A effectuates the bifurcation of the duct system 432.

The first opening of the back T-pipe 432A faces backward. The second opening of the back T-pipe 432A faces forward. The third opening of the back T-pipe 432A faces downward.

The first opening of the back T-pipe 432A is attached to the air emitting end of the blower 418. The flexible duct 432B is a flexible duct having a first opening, a second opening, and a middle region between the first and second openings. The flexible duct 432B is disposed nearly longitudinally along the top side of the undercarriage 436.

The first opening of the flexible duct 432B is attached to the second opening of the back T-pipe 432A. The middle region of the flexible duct 432B occupies the longitudinal orifice of the upright barrier 408. The front vertical duct 432C is a duct having a top opening and a bottom opening that is disposed vertically.

The front vertical duct 432C (not labeled and not visible) occupies the front vertical orifice of the undercarriage 436. The top opening of the front vertical duct 432C is attached to the second opening of the flexible duct 432B. The bottom opening of the front vertical duct 432C is attached to the top side of the front air bearing 412A. The blower 418 provides air to the front air bearing 412A through the flexible duct 432B and the front vertical duct 432C. The pressurized air inflates the front air bearing 412A.

The back vertical duct 432D (not labeled and not visible) is a duct having a top opening and a bottom opening that is disposed vertically. The back vertical duct 432D occupies the back vertical orifice of the undercarriage 436. The top opening of the back vertical duct 432D is attached to the third opening of the back T-pipe 432A.

The bottom opening of the back vertical duct 432D is attached to the top side of the back air bearing 412B. The blower 418 provides air to the back air bearing 412B through the back vertical duct 432D. The pressurized air inflates the back air bearing 412B.

The control box 448 is a multi-channel switching device for controlling the devices on the sliding loader. The control box 448 is attached near the top end of the back side of the upright barrier 408. The control box 448 receives power from the battery 420. The control box 448 activates the other power consuming devices on the sliding loader by providing power to the power consuming devices.

The control box power cable 438 is an electrical power cable having a first end, a second end, a positive wire, and a negative wire. The first end of the positive wire of the control box power cable 438 is attached to the positive battery terminal connector 456A. The first end of the negative wire of the control box power cable 438 is attached to the negative battery terminal connector 456B.

The control box power cable 438 splits at the first end of the power cable to allow the connections to the positive and negative terminals of the battery. The second end of the control box power cable 438 is attached to the control box 448. The control box power cable 438 conducts electrical power from the battery 420 to the control box 448.

The blower power cable 442 is an electrical power cable having a first end and a second end. The first end of the blower power cable 442 is attached to the control box 448. The second end of the blower power cable 442 is attached to the blower 418.

The blower power cable 442 provides electrical power to the blower 418. When the control box 448 sends power through the blower power cable 442 to the blower 418, the blower 418 functions to send air through the duct system 432 to the air bearings 412.

The operator handles 430 are two handles for controlling the movement of the sliding loader. The operator handles 430 are attached near the top end of the back side of the upright barrier 408. The operator pushes or pulls on the operator handles 430 to effectuate the desired movement of the sliding loader.

The pump supports 426 are transversely disposed support structures. The pump supports 426 have a flat base surface and a concave upper surface formed by an arc having a longitudinal axis. The pump supports 426 are disposed above the undercarriage 436 on the left side of the undercarriage near the front end of the undercarriage. The flat base surfaces of the pump supports 426 are attached to the undercarriage 436.

The hydraulic pump 424 is a fluid pump for pumping hydraulic fluid to the elevating hydraulic actuator 478 and the extending hydraulic actuator 464. The hydraulic pump 424 has a cylindrical outer surface. The concave upper surfaces of the pump supports 426 cradle the cylindrical outer surface of the hydraulic pump 424. The hydraulic pump 424 is attached to the pump supports 426 on the left side near the front end of the undercarriage 436.

The extending hydraulic hoses 428 are hydraulic ducts having a first open end and a second open end. The first open ends of the extending hydraulic hoses 428 attach to the hydraulic pump 424. The second open ends of the extending hydraulic hoses 428 attach to the extending hydraulic actuator 464. The extending hydraulic hoses 428 are two hydraulic hoses that carry hydraulic fluid to and from the extending hydraulic actuator 464.

The elevating hydraulic hoses 434 are hydraulic ducts having a first open end and a second open end. The first open ends of the elevating hydraulic hoses 434 attach to the hydraulic pump 424. The second open ends of the elevating hydraulic hoses 434 attach to the elevating hydraulic actuator 478. The elevating hydraulic hoses 434 are two hydraulic hoses that carry hydraulic fluid to and from the elevating hydraulic actuator 478.

The pump power cable 414 is an electrical power cable having a first end and a second end. The first end of the pump power cable 414 is attached to the control box 448. The second end of the pump power cable 414 is attached to the hydraulic pump 424. The pump power cable 414 has multiple wires to provide power to different aspects of the hydraulic pump 424 and control different aspects of the hydraulic pump.

The solenoid power cable 410 is a multiply branched electrical power cable having a first end and four second ends. The first end of the solenoid power cable 410 is attached to the control box 448. The solenoid power cable 410 bifurcates into a front branch and a back branch. Each branch of the solenoid power cable 410 bifurcates into a right second end and a left second end.

The four second ends of the solenoid power cable 410 are the front branch right second end, the front branch left second end, the back branch right second end, and the back branch left second end. Each one of the four second ends of the solenoid power cable 410 is attached to a solenoid 416 of the solenoid actuated wheels (not labeled) on each of the four corners of the sliding loader.

The front branch right second end of the solenoid power cable 410 provides power to the solenoid 416A. The front branch left second end of the solenoid power cable 410 provides power to the solenoid 416B. The back branch right second end of the solenoid power cable 410 provides power to the solenoid 416C. The back branch left second end of the solenoid power cable 410 provides power to the solenoid 416D.

The control box 448 controls the actuation of the solenoid actuated wheels (not labeled) by sending power to the solenoids 416 through the solenoid power cable 410 to actuated the pistons on the solenoids. When the control box 448 sends power to the solenoids 416, the solenoid actuated wheels vertically displace to raise or lower the solenoid actuated wheels in relation to the undercarriage 436.

The hoist base pivot pin 444 is a structural pin for pivotably mounting the hoisting member 450 onto the hoist base 446. The hoist base pivot pin 444 has a left end, a middle region, and a right end. The middle region of the hoist base pivot pin 444 occupies the transverse orifice near the top end of the hoist base 446. The left end of the hoist base pivot pin 444 protrudes from the left side of the hoist base 446. The right end of the hoist base pivot pin 444 protrudes from the right side of the hoist base 446.

The hoisting member 450 is a structural member having a cylindrical shape and a shackle end. The shackle end of the hoisting member 450 is on the back end of the hoisting member 450. The shackle end of the hoisting member 450 is positioned with the axes of the orifices of the shackle end disposed transverse and horizontal to the sliding loader. The shackle end of the hoisting member 450 has a right and left orifice. The shackle end of the hoisting member 450 is labeled 440 in FIG. 4. The shackle end 440 allows the hoisting member 450 to be pivotably attached to the hoist base 446.

The left orifice of the shackle end 440 is occupied by the left end of the hoist base pivot pin 444. The right orifice of the shackle end 440 is occupied by the right end of the hoist base pivot pin 444. When the hoist base pivot pin 444 occupies the transverse orifice of the hoist base 446 and the orifices of the shackle end 440, the hoist base pivot pin pivotably attaches the hoisting member 450 to the hoist base 446 to form a pivoting joint.

The hoisting member 450 has a longitudinal orifice extending nearly completely through the hoisting member from the front end of the hoisting member 450 nearly to the back end of the hoisting member 450 along a central axis for the cylindrical shape of the hoisting member 450.

The extending hoist connector 458 is a planar structural member disposed in a longitudinal and vertical plane. The extending hoist connector 458 has a top end and a bottom end. The bottom end of the extending hoist connector 458 is attached to the top side of the back end of the hoisting member 450. The extending hoist connector 458 has a transverse orifice near the top end of the extending hoist connector 458 that extends completely through the extending hoist connector 458.

The elevating hoist connector 452 is a planar structural member disposed in a longitudinal and vertical plane. The elevating hoist connector 452 has a top end and a bottom end. The elevating hoist connector 452 has a transverse orifice near the bottom end of the elevating hoist connector 452 that extends completely through the elevating hoist connector 452. The top end of the elevating hoist connector 452 is attached to the bottom side of the front end of the hoisting member 450.

The front elevating pin 454 is a structural pin that is disposed transversely. The front elevating pin 454 has a left end, a middle region, and a right end. The middle region of the front elevating pin 454 occupies the transverse orifice of the elevating hoist connector 452. The left end of the front elevating pin 454 protrudes from the left side of the transverse orifice of the elevating hoist connector 452. The right end of the front elevating pin 454 protrudes from the right side of the transverse orifice of the elevating hoist connector 452.

The elevating hydraulic actuator 478 is a hydraulic actuator having a reservoir base and a piston. The reservoir base of the elevating hydraulic actuator 478 has a top side, a bottom side, a front end, and a back end. The piston of the elevating hydraulic actuator 478 is labeled 480. The piston 480 is on the front end of the elevating hydraulic actuator 478. The reservoir base of the elevating hydraulic actuator 478 is positioned rearward of the piston 480. The reservoir base of the elevating hydraulic actuator 478 has a shackle end on the back end of the reservoir base.

The elevating hydraulic actuator 478 is disposed in a longitudinal and vertical plane. The shackle end of the reservoir base of the elevating hydraulic actuator 478 is labeled 490 in FIG. 4. The shackle end 490 has a right orifice and a left orifice. The shackle end 490 is positioned with the axes of the orifices of the shackle end disposed transverse and horizontal to the sliding loader.

The left orifice of the shackle end 490 is occupied by the left end of the back elevating actuator pin 484. The right orifice of the shackle end 490 is occupied by the right end of the back elevating actuator pin 484. When the back elevating actuator pin 484 occupies the transverse orifice of the elevating actuator base 486 and the orifices of the shackle end 490, the back elevating actuator pin 484 pivotably attaches elevating hydraulic actuator 478 to the elevating actuator base 486 to form a pivoting joint.

The piston 480 of the elevating hydraulic actuator 478 has a front end and a back end. The front end of the piston 480 has a shackle end (not labeled). The shackle end of the piston 480 has a right orifice and a left orifice. The back end of the piston 480 is positioned within the reservoir base of the elevating hydraulic actuator 478.

The shackle end of the piston 480 is positioned with the axes of the orifices of the shackle end disposed transverse and horizontal to the sliding loader. The right end of the front elevating pin 454 occupies the right orifice of the shackle end of the piston 480. The left end of the front elevating pin 454 occupies the left orifice of the shackle end of the piston 480. When the front elevating pin 454 occupies the transverse orifice of the elevating hoist connector 452 and the orifices of the shackle end of the piston 480, the front elevating pin 454 pivotably attaches the elevating hydraulic actuator 478 to the hoisting member 450 to form a pivoting joint.

When the piston 480 moves forward, the hoisting member 450 elevates by pivoting upwards. When the piston 480 moves backward, the hoisting member 450 lowers by pivoting downwards. The piston 480 moves in response to hydraulic fluid moving in the elevating hydraulic actuator 478 from the elevating hydraulic hoses 434.

The extending boom 472 is a cylindrical structural member having a front end, a middle region, a back end, a top side, and a bottom side. The back end of the extending boom 472 occupies the longitudinal orifice of the hoisting member 450. The front end of the extending boom 472 protrudes from the longitudinal orifice of the hoisting member 450.

The boom hook support 474 is a block shaped member that is attached to the front end of the bottom side of the extending boom 472. The boom hook support 474 extends below the extending boom 472. The boom hook support 474 has a transverse orifice extending completely through the boom hook support 474.

The extending boom connector 470 is a planar member disposed in a longitudinal and vertical plane. The extending boom connector 470 has a top end and a bottom end. The extending boom connector 470 has a transverse orifice extending completely through the top end of the extending boom connector. The bottom end of the extending boom connector 470 is attached to the top side of the front end of the extending boom 472 where it extends from the hoisting member 450.

The back extending pin 460 is a structural pin that is disposed transversely. The back extending pin 460 has a left end, a middle region, and a right end. The middle region of the back extending pin 460 occupies the transverse orifice of the extending hoist connector 458. The left end of the back extending pin 460 protrudes from the left side of the transverse orifice of the extending hoist connector 458. The right end of the back extending pin 460 protrudes from the right side of the transverse orifice of the extending hoist connector 458.

The extending hydraulic actuator 464 is a hydraulic actuator having a reservoir base and a piston. The extending hydraulic actuator 464 is disposed in a longitudinal and vertical plane. The reservoir base of the extending hydraulic actuator 464 has a top side, a bottom side, a front end, and a back end. The piston of the extending hydraulic actuator 464 is labeled 466 in FIG. 4. The piston 466 is on the front end of the extending hydraulic actuator 464. The reservoir base of the extending hydraulic actuator 464 is positioned rearward of the piston 466. The reservoir base of the extending hydraulic actuator 464 has a shackle end.

The shackle end of the reservoir base of the extending hydraulic actuator 464 is labeled 462 in FIG. 4. The shackle end 462 has a right orifice and a left orifice. The shackle end 462 is positioned with the axes of the orifices of the shackle end disposed transverse and horizontal to the sliding loader.

The right end of the back extending pin 460 occupies the right orifice of the shackle end 462. The left end of the back extending pin 460 occupies the left orifice of the shackle end 462. When the back extending pin 460 occupies the transverse orifice of the extending hoist connector 458 and the orifices of the shackle end 462, the back extending pin 460 attaches the extending hydraulic actuator 464 to the hoisting member 450. This joint does not pivot.

The piston 466 has a shackle end and a reservoir end. The reservoir end of the piston 466 is inside the reservoir base of the extending hydraulic actuator 464. The shackle end (not labeled) of the piston 466 is on the front end of the piston 466.

The shackle end of the piston 466 has a right and left orifice. The shackle end (not labeled) of the piston 466 is positioned with the axes of the orifices of the shackle end disposed transverse and horizontal to the sliding loader. The piston 466 of the extending hydraulic actuator 464 extends away from the reservoir base of the extending hydraulic actuator 464.

The front elevating pin 468 is a pin that is disposed transversely. The front elevating pin 468 has a left end, a middle region, and a right end. The middle region of the front elevating pin 468 occupies the transverse orifice of the extending boom connector 470. The right end of the front elevating pin 468 occupies the right orifice of the shackle end of the piston 466. The left end of the front elevating pin 468 occupies the left orifice of the shackle end of the piston 466. The piston 466 of the extending hydraulic actuator 464 is attached to the extending boom 472 by the front elevating pin 468 and the extending boom connector 470. This joint does not pivot.

When the piston 466 moves forward, the extending boom 472 extends outward from the hoisting member 450. When the piston 466 moves backward, the extending boom 472 retracts within the hoisting member 450. The extending hydraulic hoses 428 are attached to the reservoir base of the extending hydraulic actuator 464. The piston 466 moves in response to hydraulic fluid moving in the reservoir base of the extending hydraulic actuator 464 from the extending hydraulic hoses 428.

The hook ring 476 is a nearly triangular shaped ring. The hook ring 476 has a right end, a left end, a top end, and a bottom end. The hook ring 476 has a top right end vertex, a top left end vertex, and a bottom end vertex that points downward. The top end of the hook ring 476 occupies the transverse orifice of the boom hook support 474.

The payload hook 402 is a mechanical hook having a top end and a bottom end. The payload hook 402 occupies a longitudinal plane with the hook pointing forward. The top end of the payload hook 402 has a transverse orifice extending completely through the top end of the payload hook 402. The payload hook hooks payloads onto the front end of the extending hoist lifting means. The bottom vertex of the hook ring 476 occupies the transverse orifice of the payload hook 402.

In FIG. 5, a version of an improved air bearing is depicted. The improve air bearing is labeled 500. The air bearing 500 has a top surface 502; an inflatable chamber 504; a bottom surface 514; eight eye bolts 508 (some visible and some not visible); four elastic members 510 (some visible and some not visible); a perimeter frame 506; and eight hex nuts 512 (some visible and some not visible).

The top surface 502 is a planar member disposed horizontally. The top surface 502 has a top side and a bottom side. The top surface 502 has a vertical orifice (not visible) extending completely through the planar structure. The vertical orifice of the top surface 502 receives pressurized air from a forced air means.

The top surface 502 has four attachment sites (two visible and two not visible). The attachment sites of the top surface 502 are horizontal projections that extend outward from the planar member. The attachment sites of the top surface 502 are positioned midway on the horizontal expanse of the lateral sides of the top surface 502. Each attachment site of the top surface 502 has a vertical orifice extending completely through the attachment site. Each vertical orifice of the attachment sites of the top surface 502 has a well that projects downward into the vertical orifice of the attachment site. The wells of the top surface 502 are made for completely receiving the hex nuts 512 (not labeled and generally not visible).

The inflatable chamber 504 is a vacuous compartment existing between the top surface 502 and the bottom surface 514. The inflatable chamber 504 is nearly cubic shaped and has four sides of material that partially encloses a vacuous space within the inflatable chamber 504. The four sides of material of the inflatable chamber 504 are vertically disposed. The four sides of material of the inflatable chamber 504 are the perimeter material of the inflatable chamber 504.

The perimeter material of the inflatable chamber 504 is a flexible material that is non-porous or nearly non-porous. The perimeter material of the inflatable chamber 504 has a top end and a bottom end.

The vacuous space within the inflatable chamber 504 is continuous with the vertical orifice of the top surface 502. The top end of the perimeter material of the inflatable chamber 504 is attached to the bottom side of the top surface 502. Pressurized air from a forced air means passes through the vertical orifice of the top surface 502 and enters the inflatable chamber 504. The perimeter material impedes pressurized air from escaping the inflatable chamber 504 through the perimeter material.

The bottom surface 514 is a planar member disposed horizontally. The bottom surface 514 has one or more vertical orifices extending completely through the planar member of the bottom surface 514. In FIG. 5, many vertical orifices can be seen in the bottom surface 514. The pressurized air inside the inflatable chamber 504 may exit the inflatable chamber 504 through the vertical orifices of the bottom surface 514.

The lower end of the perimeter material of the inflatable chamber 504 is attached to the bottom surface 514. The top surface 502, the bottom surface 514, and the perimeter material of the inflatable chamber 504 form the boundaries of the vacuous space of the inflatable chamber 504. The inflatable chamber 504 inflates when pressurized air enters the inflatable chamber 504. The inflatable chamber 504 is capable of deflating.

The bottom surface 514 is capable of moving with the movement of the inflatable chamber 504. The inflatable chamber 504 mainly expands and contracts vertically. The bottom surface 514 raises and lowers with the vertical movement of the inflatable chamber 504. The bottom surface 514 is a smooth surface for sliding upon underlying surfaces.

The perimeter frame 506 is a rectangular framework having four connected sides disposed end to end horizontally and an empty space within the enclosure of the four connected sides. The perimeter frame 506 has four attachment sites. The perimeter frame 506 has a horizontal ledge that projects inwardly from the perimeter framework into the empty space of the perimeter frame 506. The horizontal ledge of the perimeter frame 506 supports the bottom surface 514 by providing a support surface upon which the bottom surface 514 resides. The perimeter frame 506 is attached to the bottom surface 514.

The attachment sites of the perimeter frame 506 are horizontal projections that extend outward from the perimeter framework away from the bottom surface 514 of the improved air bearing. Each attachment site of the perimeter frame 506 projects in a different direction. The attachment sites of the perimeter frame 506 are positioned midway on the horizontal expanse of the lateral sides of the perimeter frame 506. Each attachment site of the perimeter frame 506 has a vertical orifice extending completely through the attachment site. Each vertical orifice of the attachment site of the perimeter frame 506 has a well that projects upward into the vertical orifice. The wells of the perimeter frame 506 are made for completely receiving the hex nuts 512.

The eye bolts 508 have an eye region on one end and a threaded end on the opposing end. The threaded ends of the eye bolts 508 occupy the vertical orifices of the attachment sites of the perimeter frame 506 and the attachment sites of the top surface 502. The eye bolts 508 that occupy the attachment sites of the perimeter frame 506 have their eye region positioned upward and the threaded end positioned downward. The eye bolts 508 that occupy the attachment sites of the perimeter frame 506 are the lower eye bolts.

The eye bolts 508 that occupy the attachment sites of the top surface 502 have their eye region positioned downward and the threaded end positioned upward. The eye bolts 508 that occupy the attachment sites of the top surface 502 are the upper eye bolts. The hex nuts 512 thread onto the threaded end of the eye bolts 508, whether upper or lower eye bolts. The hex nuts 512 attach the eye bolts 508 to the attachment sites.

The eye bolts 508 are held in place within the attachment sites with hex nuts 512. The hex nuts 512 occupy the wells of the attachment sites. The wells of the attachment sites receive the hex nuts 512 making the hex nuts 512 recessed within the respective surfaces of the top surface 502 and the perimeter frame 506.

The elastic members 510 are elastic components that are disposed vertically between the eye regions of the upper and lower eye bolts. The elastic members 510 have top ends and bottom ends. Each top end of an elastic member 510 is attached to an eye region of an upper eye bolt 508. Each bottom end of an elastic member 510 is attached to an eye region of a lower eye bolt 508.

The elastic members 510 are generally under tension. When pressurized air enters the improved air bearing and the inflatable chamber 504 of the improved air bearing, the inflatable chamber 504 inflates vertically downward to lower the bottom surface 514 and stretch the elastic members 510. The elastic members 510 are stretched when the air bearing is emitting air.

The functioning of the inflatable chamber 504 and the elastic members 510 make the bottom surface 514 and perimeter frame 506 vertically displaceable. The bottom surface 514 both lowers and emits air when pressurized air enters the inflatable chamber 504. When the downward forces of pressurized air and gravity become less than the upward force of the elastic members 510, the bottom surface 514 raises in response to the elastic force from the elastic members 510.

A preferred use of the improved air bearing is with a sliding loader having undercarriage wheels. When the undercarriage wheels are supporting the mass of the sliding loader, the improved air bearing is positioned on the sliding loader with the bottom surface of the improved air bearing slightly above the underlying surface. When pressurized air enters the improved air bearing, the bottom surface of the improved air bearing lowers to abut the underlying surface.

As the pressure is increased within the improved air bearing and the air pressure overcomes the mass of the sliding loader, the bottom surface of the improved air bearing increases the vertical displacement between the top surface and the bottom surface, the sliding loader raises slightly, the undercarriage wheels raise above the underlying surface, the undercarriage wheels stop supporting the mass of the sliding loader, and the improved air bearings support the mass of the sliding loader.

The improved air bearings can be used to replace non-vertically displaceable air bearings. The improved air bearings can be used whenever the particular application or use makes vertical displacement desirable. The improved air bearing is a preferable feature on a sliding loader having undercarriage wheels.

The previously described embodiments of the present invention have many advantages, including the capacity to move the sliding loader and several hundred pounds of payload with some physical effort by the operator while incurring little physical stress on the body of the operator; in the case of baggage handling, the ability to move many items of baggage at a time and do it faster; the capability to move payloads in a flammable or explosive environment without having an ignition, sparking, or heated source; in the case of baggage handling, having a sliding loader that is equipped with personal comfort devices for cooling the baggage handlers when working on a very hot day in the breezeless space of a baggage compartment; a compact and lightweight design that can be transported easily and yet has the capacity to perform much work; and a lightweight design that has its horizontal motion human powered to have less of a capacity for damaging payloads as opposed to a horizontally motorized version of an implement for doing the same tasks.

The different versions of the invention have elements that can be substituted with other elements. The different versions of the invention have configurations that can be substituted with other configurations. There are many different embodiments of the invention that can be contemplated by those skilled in the art.

A seat for the operator is an optional feature. Electric motors, electric components, and internal combustion engines are optional features on some embodiments of the invention.

Wheels are an optional feature. Some embodiments of the invention may have motorized wheels for horizontally moving the sliding loader by rotating the wheels about a horizontal axis. A powering means that is separate from the lifting means is an optional feature.

Some embodiments have wheels with braking systems attached to the wheels. Brakes are an optional feature. Some embodiments have castered wheels wherein the wheels rotate on horizontal axes by having the vertical shank of the castered wheels rotate on a vertical axis.

Some embodiments have vertically displaceable wheels that can extend, retract, or extend and retract. The vertically displaceable wheels can be manually operated or actuated by actuators, particularly pneumatic actuators, hydraulic actuators, solenoid actuators, and electromechanical actuators. The vertically displaceable wheels can also be motorized for horizontal movement of the sliding loader. The vertically displaceable wheels can have braking systems.

Some embodiments have wheels that engage the underlying surface when air is not being emitted from the bottom side of the sliding loader and disengage the underlying surface when air is being emitted from the bottom side of the sliding loader. In these embodiments, the air bearings increase their vertical size when air is being emitted.

A kind of braking system can be achieved on some embodiments by having a switch that quickly discontinues the emission of air from the bottom surface of the sliding loader when a brake pedal is pushed by the operator. When the air is no longer emitted, friction is increased between the air bearings and the underlying surface. The increase in friction may be enough to stop horizontal motion of the sliding loader.

Another similar braking system can be achieved by including one or more pressure release valves in the air bearings, air ducts, or the forced air means whereby a switch can be activated to quickly release the air pressure. With no or very little air pressure, the air bearings stop emitting air and friction is increased. This friction may be enough to stop horizontal motion of the sliding loader. If some parts of the bottom surface of the sliding loader are lined with rubber or an abrasive surface, there would be an increase in friction when the air bearings deflate and the bottom surface engages the underlying surface.

There can be many different kinds of braking systems. Braking systems can be disk brakes, drum brakes, electromagnetic brakes, hydraulic brakes, air brakes, compression release engine brakes, high friction components engaging moving surfaces, or rubber pads on the bottom side of the undercarriage to engage the underlying surface when the air bearings deflate.

The different embodiments of the invention allow an operator to move payloads without using wheels. The wheels are optional and additional features to the inventive concept. The air bearings on the embodiments are the elements that allow the sliding loader to slide, not roll, when the air bearings are emitting air from the bottom surface of the air bearings.

The air bearings function best when the forced air means is delivering air at the correct pressure and volume for the air bearings. Many manufactured air bearings have manufacturer suggested air volume and pressure stated for the model of air bearing. To get the best functionality from the sliding loader, the forced air means should be chosen to provide the correct pressure and volume of air to the various air bearings on the sliding loader. For those users, who are unwilling to do some experimentation to find the best air pressure and volume for their particular air bearings, the Applicant recommends using manufactured air bearings and choosing the forced air means to meet the manufacturer's specification for the manufactured air bearings.

For embodiments of the sliding loader that utilize air bearings with no stated air pressure and volumes from the manufacturer, the user may have to do some experimentation by providing air to the air bearings at different pressures and volumes to attain the desired performance from the air bearings. If the user wanted to make their own air bearings, the Applicant advises making your air bearings similar to a manufacturer's non-patented air bearings that delivers the right performance characteristics and then begin experimentation using air pressures and volumes similar to the air pressures and volumes stated by that manufacturer.

If multiple air bearings are utilized on the sliding loader, the volumes of air required for the air bearings should be added together and the sum of the air volumes should be used to choose a forced air means capable of delivering that volume with the stated pressure. If air flow regulators are utilized on the sliding loader, the user may be able to place a high volume and high pressure forced air means on the sliding loader and use the air flow regulators to adjust the air flow to the air bearings to an acceptable level. Pressure release valves and air flow regulators can also be added to the sliding loader to prevent a high pressure forced air means from destroying some kinds of air bearings.

Once the sliding loader is placed at the worksite, the sliding loader is utilized by disengaging the wheels, if present, from the underlying surface, applying pressurized air to the air bearings, maneuvering the sliding loader into position by applying a horizontal force, and then actuating the lifting means in relation to a payload. Once the payload is engaged by the lifting means, a horizontal force can be applied to the sliding loader to move the sliding loader into another position and the payload can be disengaged by actuating the lifting means in relation to the payload.

The lifting means of the various embodiments function similar to the lifting means of other similarly configured lifting means on other industrial, agricultural, or construction equipment. The lifting means of the various embodiments are activated by engaging switches on the control box or by changing the position of the control handle on embodiment 300 by the operator provided there is air flow to the pneumatic actuator. Although motorized wheels could be used to apply a horizontal force to the sliding loader, the sliding loader will generally utilize a horizontal force from the operator's legs.

The inventive concept can also exist in an upright embodiment. An upright embodiment is an embodiment that has a vertical configuration attached to an undercarriage with a small horizontal surface area. An upright embodiment may lack a seat. The operator of an upright embodiment may walk or stand beside the embodiment while it is functioning.

An upright embodiment may have a payload carrier located close to the center of gravity of the upright embodiment. An upright embodiment may use a variety of forced air means. An upright embodiment may use a variety of lifting means. An upright embodiment may have wheels. An upright embodiment may have one or more air bearings.

Some embodiments of the sliding loader are capable of assisting baggage handlers in moving baggage inside the baggage compartment of a commercial airplane to decrease physical stress and on-the-job injuries of baggage handlers. These embodiments of the sliding loader are made lightweight for easier transportation, have a low vertical profile to fit into the baggage compartment, have a blower, have a forklift or platform payload carrier, and a purely vertical actuated lifting means, as depicted in embodiments 100 and 300. For baggage handling sliding loaders, an electromechanical winch is a preferred actuator on the lifting means and a battery or batteries can be used as the power supply means for the winch and the blower.

It is preferable to have narrow side to side dimensions on the sliding loader. A narrow embodiment allows the operator to have better control over the embodiment by placing their left foot on the underlying surface on the left side of the embodiment and to, simultaneously, place their right foot on the underlying surface on the right side of the embodiment. The narrow design makes the embodiment more maneuverable for individual operators to control the sliding loader while pushing it with their legs.

Some embodiments of the invention function solely on pressurized air. Some embodiments of the invention receive air from forced air supplies that are away from the embodiment. Some embodiments of the invention create pressurized air on the embodiment.

Some embodiments function on electrical power only. Some embodiments of the invention create power from internal combustion engines. Some embodiments of the invention are powered solely by batteries.

Some embodiments of the invention have wheels. Some embodiments of the invention have wheels with braking systems. Some embodiments of the invention have extendable and retractable wheels. Some embodiments of the invention have motorized wheels.

Some embodiments of the invention have wheels that only support the embodiment when the air bearings are not functioning. Some embodiments of the invention have brakes that are equipped with a switch that automatically halts the air flow to the air bearings when the brakes are engaged.

Some embodiments of the invention fit within the baggage compartment of commercial airplane. Some embodiments of the invention function from power being supplied away from the embodiment. Some embodiments of the invention function on power that is created on the embodiment. Some embodiments of the invention can operate safely in explosive or flammable environments.

The embodiment 100 can be made with a folding gantry. A folding gantry can be achieved by placing the entire lifting means on a hinge relative to the undercarriage where the lifting means folds backward onto the seat and then have a clip, a locking mechanism, a latch, a bolt, or a pin to fasten the lifting means into a working upright position, when ready to work. A folding gantry can be achieved by placing a hinge approximately half way up the gantry where the top half of the gantry folds backward onto the seat after disengaging the winch cable from the forklift and then have a clip, a locking mechanism, a latch, a bolt, or a pin to fasten the lifting means into a working upright position, when ready to work. A folding gantry decreases storage space, makes the design more compact, and makes transporting easier.

Some embodiments of the invention have no ignition sources, hot surfaces, electrical connections, motors, or electrical systems. Some embodiments can provide the operator with air to breath through a respirator that receives air from the forced air means while the sliding loader is working in low oxygen or flammable environments.

While the invention has been described with respect to a limited number of embodiments, those skilled in the art may appreciate numerous modifications and variations therefrom. Applicant intends to encompass within the language any structure presently existing or developed in the future that performs the same function. It is intended that the appended claims cover all such modifications and variations as fall within the true spirit and scope of the invention.

What is claimed is:

1. A sliding loader, the sliding loader comprising:
an undercarriage having a top side, a bottom side, a left side, a right side, a front end, and a rear end,
one or more air bearings having a top side and a bottom side,
wherein the air bearings are attached to the undercarriage, and
one or more lifting means, wherein the lifting means are attached to the undercarriage.

2. The sliding loader of claim 1, further comprising:
one or more forced air means, wherein the forced air means provides pressurized air to the air bearings and to any other device needing pressurized air.

3. The sliding loader of claim 2, wherein the forced air means is one or more ducts conveying pressurized air from one or more forced air supplies that are separate from the sliding loader.

4. The sliding loader of claim 2, further comprising:
one or more actuators, wherein the actuators are attached to the sliding loader.

5. The sliding loader of claim 2, wherein one or more lifting means has a gantry.

6. The sliding loader of claim 2, wherein one or more lifting means has a forklift.

7. The sliding loader of claim 2, wherein one or more lifting means has a scoop.

8. The sliding loader of claim 2, wherein one or more lifting means has a horizontal platform.

9. The sliding loader of claim 2, wherein one or more lifting means has a hoist.

10. The sliding loader of claim 2, wherein one or more lifting means has a hook.

11. The sliding loader of claim 2, further comprising:
one or more power supply means, wherein the power supply means provides power to any devices needing power on the sliding loader.

12. The sliding loader of claim 2, further comprising:
one or more undercarriage wheels, wherein the undercarriage wheels are attached to the undercarriage, wherein the wheels of the undercarriage wheels rotate on a horizontal axis, wherein the wheels of the undercarriage wheels are capable of occupying a position that is lower than the bottom side of the undercarriage.

13. The sliding loader of claim 12, wherein the undercarriage wheels are vertically displaceable.

14. The sliding loader of claim 12, further comprising:
one or more braking systems, wherein the braking systems are attached to the sliding loader, wherein the braking systems are able to halt the horizontal motion of the sliding loader.

15. A kit, the kit comprising:
an undercarriage having a top side, a bottom side, a left side, a right side, a front end, and a rear end,
one or more air bearings having a top side and a bottom side, wherein the air bearings can be attached to the undercarriage, and
one or more lifting means, wherein the lifting means can be attached to the undercarriage.

16. The kit of claim 15, further comprising:
one or more forced air means, wherein the forced air means can be attached to the air bearings to provide pressurized air to the air bearings.

17. An air bearing, the air bearing comprising:
an inflatable chamber having a perimeter material and possibly a vacuous space, wherein the perimeter material of the inflatable chamber has a top end and a bottom end, and
a bottom surface having one or more orifices, wherein the orifices of the bottom surface are continuous with the vacuous space of the inflatable chamber, wherein the bottom surface is attached near the bottom end of the perimeter material of the inflatable chamber.

18. The air bearing of claim 17, further comprising:
a top surface having one or more orifices, wherein the vacuous space of the inflatable chamber is continuous with the orifices of the top surface of the air bearing, wherein the top surface is attached near the top end of the perimeter material of the inflatable chamber.

19. The air bearing of claim 17, further comprising:
one or more elastic members having a first end and a second end, wherein the first ends of the elastic members are attached near the top end of the perimeter material and the second ends of the elastic members are attached near the bottom surface of the air bearing.

20. The air bearing of claim 17, further comprising:
a bottom framework, wherein the bottom framework is attached to the bottom surface of the air bearing, whereas the bottom framework can structurally support the bottom surface of the air bearing and the bottom framework can serve as an attachment site for the perimeter material of the inflatable chamber and for the elastic members.
